(19) United States
(12) Patent Application Publication
(10) Pub. No.: US 2007/0087798 A1
(43) Pub. Date: Apr. 19, 2007

(54) Morality system and method for video game: system and method for creating story, deeper meaning and emotions, enhanced characters and AI, and dramatic art in video games

(75) Inventor: Elliot McGucken, Malibu, CA (US)

Correspondence Address: ELLIOT MCGUCKEN, 24345 BAXTER DRIVE, MALIBU, CA, 90265-4753, US

(73) Assignee: ELLIOT MCGUCKEN, Malibu, CA (US)

(21) Appl. No.: 11/546,737

(22) Filed: Oct. 12, 2006

Related U.S. Application Data
(60) Provisional application No. 60/726,270, filed on Oct. 13, 2005.

(51) Int. Cl. A63F 13/00

(52) U.S. Cl. 463/1

(57) ABSTRACT

A video game and game system incorporating a game character's morality level that is affected by game occurrences such as moral, amoral, or immoral choices in an epic story's deeper context. The character's morality level affects the game's environment. Such a feedback system based on moral premises provides an efficient means to enhance and deepen game play, as a sensible, realistic, meaningful, profound, and epic story naturally emerges. The measurement of moral choices will allow a player's soul to be rendered upon the screen in cinematic action paralleling internal dramatic action, thus providing the dramatic elements of classic literature and film. The presentation of moral choices in the game, based upon moral premises, will allow plot points that result in character arcs, romantic relationships, exalted game play, and epic story. Moral choices will lead to overall success, while immoral or amoral choices will lead to overall failure.

### CROSS-REFERENCE TO RELATED APPLICATIONS

This application claims the benefit of provisional patent application Ser. No. 60/726,270

### FEDERALLY SPONSORED RESEARCH

Not applicable

### SEQUENCE LISTING OR PROGRAM

Not Applicable

### BACKGROUND OF THE INVENTION

1. Field of the Invention

This invention relates to video games, and, more particularly, to a new gameplay feature for video games, such as First Person Shooters (FPSs), Third Person Shooters (TPSs), Role Playing Games (RPGs) and the like, wherein the morality (e.g. spiritual level) of the player or game character is used to enhance game play with story, improved narratives, deeper emotions, romantic relationships, and more.

2. Introduction

This present invention pertains to introducing morality and epic storytelling into the realm of video games, resulting in video games with superior, deeper game play, expanded markets, and longer-lasting brands. The ability to render deeper emotion, story, and exalted dramatic arts within the realm of video games has been a long sought-after “holy grail” throughout the video game industry. The prior art demonstrates how others have failed and are failing to deliver more meaningful and engaging games endowed with epic storytelling. This present invention provides the missing key to realizing epic storytelling, deeper emotional involvement, and higher art in video games.
“When storytelling declines, the result is decadence,”—Aristotle

The prior art is littered with failed attempts to endow video games with epic storytelling, soul, emotion, and the eternal aspects of art. What the experts have missed in the relatively nascent video game industry is that the center and circumference of epic story, everlasting art, and deeper emotions rooted in the deeper soul is morality. The subtle or bold introduction of a “morality meter” or a “soul meter” or “spirit level meter” or “moral premise” in the realm of video games would enhance current video games as well as lead to brand-new opportunities for new video games with superior game play.

A “morality level meter” would vary according to a player's moral choices. Numerous moral choices could be made throughout a video game in the preferred embodiment, all centered around a unifying moral premise. Moral choices lead to augmented morality levels and immoral choices lead to decremented morality levels. Augmented morality levels lead to more aid from gods and angels and other in-game characters, and decremented morality levels lead to less help from gods and angels, and/or more interference from demons and devils. Such a feedback system, based on AI endowed with a moral sense, would result in epic storytelling. A simple moral premise, when woven into the game's AI, would result in deeper storytelling.

Plot points would consist of points in the game wherein the character would make a moral or immoral choice, thusly leading them along different stories wherein their internal moral code was manifested in the game's universe in the form of physical action. Thus dramatic action—the internal tensions and conflicts encompassed in making a moral decision, wherein virtue and vice battle internally—would be rendered in physical game play on the screen. The physical action and dramatic action would be unified by the moral premise, thus deepening and emboldening the experience of both; thusly resulting in a higher artistic experience in the game.

Prior to this present invention, players were given attributes such as health, strength, dexterity, intelligence, magic, and sanity. But no video game offered the player an attribute such as morality. Nor did any game in the prior art offer any display of a “moral level meter” on the screen. Nor did any game in the prior art incorporate the player's morality level into the game's AI, so that other characters may interact with the player's character in a manner proportional to the player's moral or immoral choices and moral level.

A moral level meter, which would change its value based on a player's choices, would allow for deeper, more emotionally-involved video games. Furthermore, a moral-level meter would foster new opportunities for storytelling in games, as all deeper story is fundamentally tied to morality and the protagonist's moral constitution. The game environment, including gods and angels and other players controlled both by humans and AI, would interact with the player based on the level of the player's moral meter, which may or may not be displayed upon the screen.

The present invention introduces a morality-level meter into the realm of video games. The player's actions affect the level of the morality meter, and the environment, including angels and God, and devils and demons, and other in-game characters, behave and interact with the player based on their morality level. So it is that the player's internal psychology is manifested in the narrative of the game. So it is that the player's internal moral code, spirit, and deeper soul is rendered upon the screen via their actions based on the choices they make. So it is that the player's moral premise is given a chance to more fully express itself in a new way and in a new art form. So it is that a player's conscience is given a chance to render itself real; with virtue leading to virtuous actions and success, and vice leading to dark actions and failure in the game's world. A plurality of moral choices, or plot points, may be presented throughout the video game; all of which would reflect a unified moral premise—the same kind of unified moral premise that is present in all higher art and literature.

Not only does this present invention introduce morality into video games in a novel manner, but it also introduces epic storytelling into the realm of video games, and it thus allows video games to achieve everlasting art. For every eternal classic, from The Bible, to The Odyssey, to Dante's Inferno, to Hamlet , is built upon the solid-oak frame of Story. And the seed of the story is the exalted moral vision of the central character—a moral premise they harbor in their souls. By providing opportunities for characters to choose whether or not to act in moral manners, and then presenting those actions with consequences via the deeper moral conscience of the video game, reflected in a morality level meter, and/or the exalted or fallen behavior other characters controlled by AI or by humans, video game characters are allowed to evolve in deeper, more meaningful ways. And furthermore, stories are naturally allowed to evolve—epic, classical stories based upon moral premises—both those within the game's AI and within the player's soul.

All action in classical drama is but the physical manifestation of the internal conflict—of the character's moral code. We enjoy watching movies and reading books where Hero's adhere to their moral code causing external conflicts. No matter how bad the physical or emotional pain gets, they yet adhere to the virtuous side of the moral premise. Such reasons are why The Odyssey, The Trial of Socrates, and the Gospels embody classical art and religion.

So it is that the present invention will offer deeper video game play by allowing the player's moral code to be rendered in a physical story upon the screen. We love film, movies, and books because they present us with characters with moral dilemmas. Heroes, from Odysseus on down, from Braveheart on back, are those who can forgo short-term temptations for the eternal aspects of art and culture. Heroes are those who can forgo fleeting wealth for eternal love and freedom, who can place and keep the higher ideals over the bottom line. Heroes are those who, when confronted with temptation and the immoral, yet walk the straight and narrow. A video game that included the morality system and method described in this present invention would allow players to become heroes on a spiritual level, and have that spiritual level rendered in the action on the screen, just as Mel Gibson rendered William Wallace's immortal soul in physical action in Braveheart. Such a video game, that allowed a player to become a hero on a spiritual level while also allowing them to engage in parallel physical actions in the game, would be novel, unique, and sought-after by many.

The prior art has lacked the notion of morality, and lacking this feature, greater insight into one's soul was not gained via game play, which merely constituted physical missions and graphic campaigns without a deeper moral level meter nor any sense of a moral premise. Thus the dramatic depths of epic stories such as Braveheart and The Lord of The Rings were and are absent from video games.

### FURTHER BACKGROUND OF THE INVENTION

Video games, such as RPGs and the like, typically include a game character that proceeds through the game while one or more physical conditions or attributes of the character, such as injury, health, strength and/or stamina, are monitored by the game. For example, such video games have monitored the level of injury or health that a character has sustained during gameplay by, for instance, engaging in fights with enemy characters. Such video games have also been programmed to cause the game to end as a result of the player reaching a certain threshold for one or more of the monitored physical conditions, such as level of injury. In other words, if a player's injury level rises to a predetermined level, or if their health level falls to a predetermined level, the player may be considered by the game to have been killed during gameplay or injured to a point that the player cannot continue the game. Such a player would be dead, and such a circumstance would be tantamount to the end of the game. While these and other similar features have been successful in video games, game developers continue to seek new, interesting, exciting and/or challenging features for video games. And more particularly, the video game industry is avidly seeking ways to incorporate deeper storytelling within more emotionally-involved video games, thusly resulting in superior video games and novel forms of entertainment that will lead to brand new revenue streams. The present invention was developed in order to meet this need for new gameplay features. The present invention overcomes problems seen by experts in the industry such as Dave Jaffe, “A lot of games feel really soulless and heartless to me.”—Dave Jaffe, Creative Director, Sony Santa Monica Studios, in GameInformer #150, The World's #1 Computer & Video Game Magazine.

The moral sense is what marks humans unique in this universe. Morality is where all character is rooted, and thus in order to render realistic characters on a spiritual level, the present invention will be needed by the video game industry. Morality lies at the center and circumference of storytelling. Morality determines what makes us laugh and what makes us cry. It is via choices based on morality that story emerges in all classical literature. The moral dilemma is at the crux of dramatic action, wherein the destiny is decided by the moral, amoral, or immoral choices one makes. And thus this present invention will revolutionize the video game industry by providing games with epic storytelling capabilities.

In the 2007 Guide to Making Movies published by Movie Maker Magazine, Stanley D. Williams writes, “All the star power in the world can't help a film lacking a moral premise . . . Since the first stories were ever told, only one thing has ever consistently and successfully connected the storyteller with his or her audience: The Moral Premise.” So too is it that all the processing power and pixel counts in the world can't add to the story. When considering the dramatic arts in his Poetics, Aristotle ranked story first and spectacle second to last. Thus video games and a lot of contemporary movies fall short of exalting, engaging entertainment, as does video game AI which never contemplates, nor includes, nor embodies, nor seeks to embody, nor manifests a moral premise.

Stanley D. Williams goes on to say in Movie Maker Magazine, “On paper, the Moral Premise is a once-sentence description of the physical and psychological arcs of a movie's main characters. The Moral Premise focuses the storytelling in one direction and inextricably links the main characters' motivations with their physical action.”

So it is that by adapting an entity that forms the foundation of successful movies, video games may reach a brand new plateau. Within the context provided by morality, and more specifically, within the context provided by a moral meter, and moral premise, the character's physical actions in a game take on a deeper meaning, as the physical actions are really manifesting the internal soul, just as they do in movies.

Stanley D. Williams goes on to say in Singular Sensation in the Guide to Making Movies 2007 published by Movie Maker Magazine, “In order for a story to be successful and connect with its audience, it must present evidence towards some conclusion. In the courtroom, every piece of evidence, like the final conclusion, is called ‘a premise.’ In a story, individual scenes are like the pieces of evidence or premises. As the scenes pile up, the story leads us to the character's physical climax, and, more importantly, to a psychological or moral conclusion. It is this moral conclusion, or premise, that drives everything physical that we see on the screen.”

The dramatic device of a “moral premise,” when introduced into video games in a manner disclosed in this present invention, will endow video games with epic storytelling capabilities. So it is that deeper story may be gained by incorporating the notion of morality in video games in both subtle and not-so-subtle manners, including presenting players with moral choices, altering the player's morality level based on their choices, altering the surrounding character's morality levels based on the first player's choices and other players choices, and having devils and demons, and angels and gods, intervene to help or hurt the character based on their morality levels.

So it is that classical literature might be rendered in the realm of video games. And so it is that deeper, more exalting games, capturing that elusive Holy Grail of “storytelling in video games,” that has eluded so many experts for so long.

Furthermore, the environment will change in accordance with the character's actions, creating even deeper game play. The environment could include gods and angels and other in-game characters which would react positively or negatively to the player's moral or immoral choices and moral actions. For instance, the gods and angels could help the player with tips, guidance, and spiritual help when the player was making the right choices. Alternatively, they could abandon and desert the player when the player was doing immoral things, and the player would end up in a meaningless, open-ended game. The environment could include demons and devils which would seek to impede or hurt the player's progress, when they player strayed from the straight and narrow via immoral or amoral choices. So it is that the struggle between virtue and vice in the player's soul could be rendered on the screen, and the deeper dramatic action could inspire the physical action, which in turn would exalt the spirit in deeper, meaningful entertainment.

Stanley D. Williams goes on to say in Singular Sensation in The Guide to Making Movies 2007 published by Movie Maker Magazine, “For your story to be accepted by mainstream audiences, your Moral Premise must be true and consistent with natural law—taking everything from nature's law of gravity to a human being's feelings of injustice into consideration.”

Mr. Williams is talking about movies, and this present invention is novel in that takes Mr. Williams' expert advice and applies it to video games in a novel manner, fostering unexpected and previously unseen results, including deeper story in video games, augmented markets for video games, better videogaming experiences, and a brand new realm of videogames capable of epic storytelling, moral education, and eternal art.

An embodiment of present invention would include a Moral Premise that is true and consistent with natural law, based on the Bible, Dante's Inferno, and other works of literature espousing and rewarding moral behavior in this open-ended world. Just as realistic physical action demands a realistic physics engine grounded in classical physics, realistic emotion and storytelling demands a game engine grounded in classical literature.

The present invention surpasses prior art such as Sanity system for video game described in U.S. Pat. No. 6,935,954, which is described as, “A video game and game system incorporating a game character's sanity level that is affected by occurrences in the game such as encountering a game creature or gruesome situation. A character's sanity level is modified by an amount determined based on a character reaction to the occurrence such as taking a rest or slowing game progress and/or an amount of character preparation. That is, if a character is prepared for the particular occurrence, the occurrence may have little or no affect on the character's sanity level. As the character's sanity level decreases, game play is effected such as by controlling game effects, audio effects, creating hallucinations and the like. In this context. the same game can be played differently each time it is played.”

While the presence of a sanity level in U.S. Pat. No. 6,935,954 leads to varied and interesting gameplay, the presence of a morality level in the present invention leads to epic storytelling, more emotionally-involving game play, deeper characters, and games that can achieve classical art on a spiritual level. The present invention surpasses in U.S. Pat. No. 6,935,954 in numerous ways, including expanded markets and audiences for video games, increased use of video games in academia, enhanced brands for video games, and novel and enhanced game play in current RPGs and FPSs and MMORPGs that choose to adapt the novel approaches of the present invention.

The present invention can lead to a renaissance in video games and usher in a brand new era of deeper and more exalting video games with deeper storytelling and a heightened cinematic experience.

So far video games have failed to incorporate a moral level ever in a subtle manner or an explicit manner. Thus the prior art lacks emotionally-engaging stories and “soul.”

Nowhere at Chris Crawford's storytronics.com website, nor anywhere in his books, nor patents, nor any of his other prior art, does he mention the central significance of a Moral Premise in storytelling in the realm of video games. Nowhere at Chris Crawford's storytronics.com website, nor anywhere in his books, nor patents, nor any of his other prior art, does he mention the possibility and advantages of the notion of morality and a moral level meter in the realm of video games. Nowhere in Chris Crawford's prior art, nor in any other prior art, is this present system and method for morality in video games presented. The present invention will have far-reaching effects throughout the industry, as it can launch both a renaissance and a revolution.

Because game developers have been unable to incorporate morality in video games on a deep, profound, realistic level, they have fallen short in creating memorable characters, deeper emotional involvement, and superior, more realistic game play. Because the moral sense is intrinsic to humanity's reality, only games with higher moral contexts can approach reality, thereby offering richer game play experiences.

In all the leading discussions on storytelling in games, and in all prior art, no mention is made of the central significance of morality to storytelling—not even in books, movies, film, and literature—and certainly not in the realm of video games.

This invention, by offering a world which is wed to the character's moral behavior, offers a unique and superior game play experience. This invention may achieves this in the following manner—the protagonist needs the help of a woman to accomplish his goal. By behaving in a moral manner, he draws her closer. By behaving in an immoral manner, he pushes her away.

The protagonist must upload a higher moral operating system into an AI robot.

The longer he waits to do this, the more the surrounding world declines, as the AI robot sends monsters forth to kill him. So it is that storytelling is finally married to gameplay in a useful manner. While the protagonist is free to do as they choose, the moral premise of the story remains the same—virtue leads to success, and vice leads to failure. If the protagonist behaves in an amoral or immoral manner, the world is lost. If the protagonist behaves in a moral manner, the world is won and the objective is achieved.

The concurrent postmodern movement has denied the absolute higher mortality that makes great movies and great books, and has blinded the video game industry to a superior level of game play that this invention offers. Thus the Hollywood box office is declining, and video games only reach a limited market of fanboys. The present invention thus will have far-reaching economic consequences.

Classical storytelling is what has granted the greatest books and movies their profound, enduring meaning, creating vast audiences over distance and time. Classical storytelling can do the same for video games. Realizing the riches of storytelling in video games is considered a Holy Grail by many of the experts searching for that “Citizen Kane” moment. This invention shows a direct path to this Holy Grail.

While some gaming industry experts wish there were a paradigm that could successfully enhance games with storytelling, other experts steadfastly insist that storytelling does not matter in video games. But, as Aristotle said, “When storytelling declines, the result is decadence.” Thus, for video games to rise above decadence, better storytelling capabilities are needed. This present invention provides the storytelling paradigm the former experts seek, while creating a superior form of game play that the latter experts deny. All concurrent experts agree that storytelling in games, and thus deeper psychological emotional involvement, has fallen short of psychological and emotional involvement in other art forms that incorporate storytelling, such as books, literature, and movies. This invention will allow games to achieve new dramatic depths and artistic heights.

Classical storytelling is rooted in morality, and the higher the moral system, the greater the classic. Thus Hamlet, with its Judeo-Christian and classical themes is the most performed, most quoted play of all time. And thus the Bible, lying at the center and circumference of the Judeo Christian Heritage, is the bestselling book of all time. Other classics influenced by the Bible include Dante's Inferno, Moby Dick, and The Lord of the Rings—all vast successes.

Thus it makes sense that a video game married to the Judeo Christian heritage on a profound level will provide better game play. This invention offers a method for marrying game play to a higher moral system.

While hiring hookers and then shooting them to get your money back in Rock Star's® Grand Theft Auto can be very enjoyable to a certain segment of the population, fighting for Honor, Truth, and Glory—fighting for the innocence at the center and circumference of a woman's soul—would offer far superior game play with deeper emotional involvement.

### OBJECTS AND ADVANTAGES—INTRODUCTION

The present invention has numerous objects and advantages. The present invention would enhance many existing video games with more immersive storytelling, more memorable and realistic characters, deeper emotional involvement, and higher art. And too, the present invention would foster a new breed of superior video games, including the Dante's Inferno Game, The Odyssey Game, and the Autumn Rangers Game. The present invention, holding the key to epic storytelling in the realm of video games, would allow the Great Books and Classics, from the Iliad, to The Odyssey, to the Bible, to be brought to life in the realm of video games.

Furthermore, the present invention would expand the video game market by attracting players who are more interested in the emotional involvement and deeper storytelling that classic films, novels, and literature provide. Furthermore, the present invention would foster a vast and new marketplace in the realm of educational gaming. Furthermore, the present invention would foster a vast and new marketplace amongst parents who are concerned about the intellectual and moral development of their children, who would look for games marked with “With the Beatrice Game Engine Moral Meter™,” or “With The Beatrice Game Engine Morality™,” or “With the Beatrice Game Engine™,” or with the “Soul Meter™.”

The addition of a “Morality Monitor” or “Soul Monitor” or “Spirituality Monitor” described within this present invention will lead to hitherto unseen and unexpected results in the realm of video games. The Morality Monitor will foster deeper storytelling, and it will lead to more immersive game play. The present morality method and system for video games is the Holy Grail of the current video game industry, which is seeking novel methods to create new and different game play, as well as ways to make video games that achieve higher, exalted, and eternal art. The present invention provides these novel methods, thereby also introducing lasting brands in a fleeting industry where today's technologically cutting-edge game is in tomorrow's bargain-bin.

Throughout the video game industry, debates rage as to how best achieve immortal art through video games which tend to age quickly, and how to introduce greater emotional involvement and expand the market for video games. This present invention will allow video games to achieve higher, immortal art by introducing morality to the player, a moral context within the world of the game, and a moral premise throughout, and it will expand the market for video games by reaching out to those who enjoy more meaningful entertainment such as that provided by the literary and dramatic arts.

It is widely reported that the current “next generation” games are just yesterday's games with better graphics: Tuesday, 3 Oct. 2006 INTERVIEW: LucasArts' Next Generation Plan By Colin Campbell:
http://www.next-gen.biz/index.php?option=com_content&task=view&id=3933&Itemid=2
In a hotel near London's Marble Arch, we met yesterday with Williams to talk about LucasArts' message at England's version of GDC, where he is due to deliver a keynote on development issues. Williams says, “It's disappointing to see the number of next generation games out there that are really current generation games with better graphics. We are committed to next-gen gameplay, to experiences that are different. The tent poles of that are doing innovative things with character and with story.”
http://www.next-gen.biz/index.php?option=com_content&task=view&id=3933&Itemid=2

The article then goes on to talk about animations, graphics, AI, and destructible environments, but nowhere does it mention morals, nor morality, nor spirit, nor soul, nor a moral meter nor, nor a morality meter, nor a moral premise. Nowhere else throughout the prior art are any of these entities mentioned in conjunction with video games.

What do eternal classics such as The Odyssey, Dante 's Inferno, Hamlet, The Lord of The Rings, and The Gospels have in common? The answer is morality. All the lead characters are concerned first and foremost with “doing the right thing.” They suffer for it, but they do the right thing. We love the stories told within these classics, because they illustrate the nobility of goodness, morality, and reason—the resounding glory of the ennobled, perceptive human soul. And the stories are only able to accomplish eternal art via the perceptive morality of the lead characters.

Odysseus only makes it back on home because he does the right thing time and again, forgoing the temptation of the Sirens and the Lotus Eaters. He behaves morally, whereas his men do not, and thus he alone makes it on back home. Dante only makes it through hell because he repents and is thus eventually reunited with Beatrice—an angel who leads him on through Purgatory and on towards Paradise. Both characters make moral choices which form the pivot points of the plot. So it is that the present invention presents moral choices as plot points. Thus it is that a simple moral premise can have far-reaching effects in producing a story.

A further advantage of the present invention is that rather than scripting out every possible scenario in an open-ended world, so as to allow player choice, this present invention advocates endowing the game's AI with a simple moral premise. Just as a moral premise unifies movies, and just as holding onto a moral premise through adversity leads to complex and great stories such as those described by Joseph Campbell's Hero's Journey, so too would a moral premise unify a game and provide the game designers an easier method for designing open-ended, realistic games, without first of all going through every possible iteration of the game.

Both The Odyssey and The Inferno are epic stories of the highest art because they exalt the moral over the immoral. Classics are classics because the main characters struggle to do the right thing, come hell r high water. Odysseus makes it to hell and back, and then on home via moral choices. Dante makes it on through hell via moral choices. Socrates is sentenced to death, after making moral choices, and his morality sets him free from wickedness, which runs far faster than death. Christ is crucified for the moral choices he makes, but he forgives everyone as he suffers for their sins, “For they know not what they do.” In every case, all these stories are classics because of the profound morality of the central character. The profound depth of classical dramatic works could be brought to life with the present invention.

And thus it is curious that in video game after video game which seemingly attempt story, and emotional involvement, there is no mention of morality. And too it is curious, that in expert panel after expert panel on story in video games, in article after article on narrative and deeper gameplay—there is no mention of morality. So it is that the present invention is non-obvious to the experts. While characters are given attributes such as strength, endurance, magic, and sanity in the prior art video games; nowhere does the attribute of morality ever have a role. Thus games in the prior art lack the story, meaning, emotional engagement, artistic consequence, deeper dramatic flair, and lasting brands that the present invention would provide.

### FIELD OF THE INVENTION: PRIOR ART

On Oct. 4^{th} 2006 I attended the dual premiere of Gears of War and the Texas Chainsaw Massacre at the AMC theaters in Los Angeles. The theater was packed for both premieres, and what struck me as odd was the lack of story in both the video game and the movie. With the Hollywood box office in decline and video games seeking to become eternal art with a “Citizen Kane Moment,” why the complete dismissal of story at an October 2006 premiere in the heart of the entertainment industry? The premieres were held jointly not so much because video games are gaining the plot and storytelling features of movies, but because both the video game and the movie feature chainsaws; and movies are becoming all spectacle and no plot—like video games. Here we are with next-generation video game consoles, and it all comes down to chainsaws. Indeed, as many experts such as Chris Crawford have noted, the pixel count is higher, but the video games are the exact same.

The presence of a morality meter on the big screen would have leant a brand new dimension to the video game, and it would have forced the video game developers to contemplate deeper gameplay via which morality would manifest itself. Pivotal plot points in movies are centered not within action sequences, but within moral sequences, wherein characters choose between various courses of action based on their internal moral code. The physical actions manifest the internal conflicts, but without internal conflict, there is no dramatic action, but only physical action. The present invention allows the internal conflict to be developed, gauged, and reacted to by the game's AI, thusly fostering enhanced dramatic action. Thus the moral code is made present and explicit, and it is this external rendering of the internal moral code, that the present invention provides, that makes the dramatic arts interesting.

A player of the novel video game described herein would get to see their moral heart and soul rendered in a new, deeper art form—within a video game with a moral meter whose environment changed with regards to morality of the player's choices. Just like real life. And so it is that as games approach photo, physical, and graphic-realism, this present invention provides spiritual, and soul realism.

Hamlet, the most performed and quoted play of all time, is all about Hamlet contemplating and seeking the correct action. It is a violent and action-packed play, but the dramatic action is centered about Hamlet's internal moral choices every step of the way. The profound beauty of Hamlet's deeper soul is manifested in the inaction and action of the play—in Hamlet's moral choices.

It is strange that video game designers ignore the tricks of the trade which masters such as Shakespeare, Dante, and Homer used to accomplish classic storytelling. The present invention is novel in that it adapts the tricks of the trade which masters such as Shakespeare, Dante, and Homer used to accomplish classic storytelling, thereby achieving everlasting art.

Though the HD graphics looked beautiful upon the screen in the October 2006 big-screen premiere of Gears of War, the dialogue was yet stilted. During the video game premiere, the crowd cheered each time the chainsaw was brought out and blood splattered everywhere, but there was no presence of a moral dilemma, nor a moral premise. The present invention has nothing against blood, gore, and violence—there are plenty of all of these entities throughout the classics such as The Iliad, The Odyssey, Dante's Inferno, and Hamlet. But the present invention introduces the moral layer which makes classical literature classical. In addition to the blood and the gore, the present invention grants story, soul, emotion, and deeper, spiritual art to the realm of video games.

Dante's Inferno and Homer's Odyssey have become everlasting brands via the exalting morals they communicate. The Odyssey contains the first showdown in all literature-Odysseus alone strings the bow and then immediately defeats all the suitors who are wooing his wife and laying all his wealth to waste in party after party. And though visual, the ultimate showdown is nothing without the deeper moral layer of the Odyssey. Odysseus would never have been able to participate in the showdown had he not behaved morally and wisely during his journey on back.

And yet the prior art video games never take a player's morality into consideration.

Taking a player's morality into consideration contradicts many experts' opinions who argue that video games are just “entertaining” and “fun,” and that entertainment has nothing to do with a moral message. Well, the center and circumference of all deeper, everlasting entertainment and art is morality. Thus this present invention allows video games to achieve deeper, more-emotionally-involving, and longer-lasting art.

Many argue that porn is entertainment, but there is no classical porn. Porn is too easy. Wide is the path to destruction, but narrow is the path to salvation. That is what makes living for higher ideals fun—it is a challenge to tell a significant story with our lives in this open-ended world. And by incorporating ideals into open-ended video games—into the game engines, the AI, and the environments; a new, higher form of open-ended video game might be produced.

In The Birth of Tragedy Nietzsche spoke of the Appollonian and Dionysian arts, and it is that battle between the two that makes life interesting. But eternity is always carried by the Appollonian, and thus anyone interested in creating eternal games of everlasting value must treat them as an Appollonian art form. They must respect plot and morality over spectacle and random shootings. All value derives from value, and thus the more successful video games will be embedded with values and higher ideals that resound throughout the Great Books and classics, throughout Shakespeare and the Bible.

In the following esteemed books that contemplate interactive intelligence, AI, story, and emotion, no mention of ideals nor morality was made: Introduction to Artificial Intelligence, Second Edition, Philip C. Jackson; On Intelligence by Jeff Hawkins; AI For Game Developers by David M. Bourg & Glenn Seemann, AI Game Engine Programming, by Brian Schwab, and AI Game Programming Wisdom, by Steve Rabin. Nor could the words ideals nor morality be found in the indices of AI Application Programming, by Tim Jones, Artificial Intelligence by Stuart Russell and Peter Norvig, nor within Character Development and Storytelling For Games by Lee Sheldon, nor within any other prior art. Thus the prior art has failed to deliver the depth of story, character, and emotion—and exalted video games—that the present invention will foster. For all epic, everlasting, deeper stories, films, and books are wed the moral premise, as is this present invention.

### SUMMARY OF THE INVENTION

In an exemplary embodiment of the present invention, a method of operating a video game including a game character controlled by a player includes (a) setting a morality level of the game character; (b) modifying the morality level of the game character and the world surrounding the character during game play according to occurrences in the game, wherein a modifying amount is determined based on said character's moral reaction and the morality of choices made by said character (c) controlling game play according to the moral level of the game character, gameplay being controlled at least by varying game effects according to the game character morality level.

Step (b) may be practiced by reducing the morality level of the game character upon the player making an immoral or amoral choice.

Step (b) may be practiced by increasing the morality level of the game character if the game character acts in a moral manner, making a moral choice, during game play.

Step (c) may be practiced by helping said game character that has a higher morality level with extra information given by a god or an angel.

Step (c) may be practiced by ignoring the game character with a lower morality level or hiding extra information and purpose from the said character.

Step (c) may be further practiced by introducing devils and demons corresponding to the morality level of the game character.

Step (c) practiced by varying game audio effects and soundtrack according to the morality level of the game character.

A “morality level meter” may be displayed on the computer screen.

Another preferred embodiment of incorporating a morality level in a video game would be to present a “morality level meter,” which would monitor a player's morality. Killing innocent bystanders would subtract from the meter. Stealing cars would subtract from the meter. Failing to kill evil demons or the enemy would subtract from the meter.

Doing the right thing would result in an augmented morality meter. Capturing car jackers and returning cars would augment the morality meter.

Sometimes, however, the correct course of action may not be readily apparent. Sometimes one must do something considered wrong in order to advance the greater good. For instance, though the Bible commands, “Thou shall not kill,” in war one must kill one's enemies, or die. Thus there are many gray areas, but their acknowledgment will not detract from game play, for Hamlet's very beauty was built around the gray areas the perceptive so often see, while the less keen see black and white. Moral choices do not always come easy—that is the crux of all the great dramatic works and movies. We love watching characters struggle with the correct moral path, and then we love watching them punished or rewarded for their choices. And the movies where ideals are manifested in action have ever been our favorite.

In another exemplary embodiment of the present invention, a method of creating story in a video game would include a game character controlled by a player, the method comprising: (a) setting a morality level of the game character; (b) presenting the character with choices requiring moral evaluation, such choices becoming plot points; (c) modifying the morality level of the game character and the world and other characters surrounding said game character during game play according to occurrences and choices made in the game, wherein a modifying amount is determined based on the morality of choices made by said game character (d) controlling game play and story according to the moral level of the game character, game play and story being controlled at least by varying game effects, environment, and behavior of other characters and entities according to the game character's morality level.

This present invention, and the notion of a morality level, could enhance virtually every game, including but not limited to The Godfather, Gears of War, Prey, Perfect Dark Zero, World of Warcraft, and the Halo Series.

And too, such a morality meter described in the present invention, or a moral level introduced in a more subtle manner via the actions of other characters in the game, could lead to brand new games, including the Dante's Inferno Game, The Odyssey Game, and the Autumn Rangers video game, as further described in the preferred embodiments section.

When a player's “moral level” is high, they are helped by the Gods and by angels such as Beatrice. Angels such as Beatrice lead them to the next level and give them hints of what to do next, or they help them out of tough binds.

When a player's “moral level” is low, they no longer see Beatrice, nor are they helped by the Gods. A player with a low moral level is abandoned to walk the meaningless streets of the game, just as a man without religion, nor a code of honor, nor a value system, is, as Bob Dylan suggested, a “dead man.”

And indifference or amorality may also lead to losing the game. For as liberty requires eternal vigilance, there are always dark consequences for players who ignore the higher calling to do the right thing. When players make immoral or amoral choices, eventually the demons will take over in Dante's Inferno, or they will never make it on back to their wife and home in The Odyssey, or the Robodrone Raptors and APRIL will overtake the world in Autumn Rangers.

### FIELD OF THE INVENTION: FURTHER PRIOR ART

In the blockbuster, state-of-the-art Xbox 360 Elder Scrolls Oblivion video game, player characteristics lack the notion of morality. At http://guides.gamepressure.com/theelderscrolls4oblivion/guide.asp?ID=948, the following is stated: “The most basic of all values that define our hero are the Attributes. There are 8 of them” Note that the 8 attributes do not include morality—the center and circumference of the advantages of this present invention:

http://guides.gamepressure.com/theelderscrolls4oblivion/guide.asp?ID=948

| Attribute | Skills governed | Values determined |
|---|---|---|
| Strength | Blade, Blunt, Hand-to- | Encumbrance, Fatigue, melee |
| | Hand. | damage. |
| Intelligence | Alchemy, Conjuration, | Mackicka, Spell Effectiveness. |
| | Mysticism. | |
| Willpower | Alteration, Destruction, | Fatigue, resistance to magic, |
| | Restoration. | Magicka regeneration rate. |
| Agility | Security, Stealth, | Fatigue, bow damage. |
| | Marksman. | |
| Speed | Acrobatics, Athletics, | Movement speed, jumping |
| | Light Armor. | height, Light Armor rating. |
| Endurance | Armorer, Block, Heavy | Fatigue, Health added when |
| | Armor. | reaching new level |
| | | (Endurance divided by 10). |
| Personality | Illusion, Mercantile, | NPCs' Disposition. |
| | Speechcraft. | |
| Luck | None. | ? |

http://guides.gamepressure.com/theelderscrolls4oblivion/guide.asp?ID=948

Note that the 8 attributes in the blockbuster Elder Scrolls Oblivion game do not include morality—the center and circumference of the advantages of this present invention. The presence of morality would add a novel and vast dimension to the gameplay.

Nor do other cutting-edge/leading xBox 360 games incorporate a moral level nor morality meter. Games such as The Godfather, Prey, Perfect Dark Zero, Harry Potter, The Matrix, and The Lord of The Rings all lack the notion of morality. The introduction of the morality method and system present invention to RPG, FPS, TPS, and MMORPG would enhance the gameplay, allow for deeper character development, and result in improved and epic storytelling. The introduction of the present system to a game such as World of Warcraft™, or any of their competitors or similar games, would allow for vastly improved gameplay. A character could be given greater depth, as over time those characters with higher moral levels would gain respect, just as Ghandi, Socrates, Jesus, Abraham Lincoln, and Mother Theresa did in the real world.

A search on http://www.google.com/search?hl=en& lr=&q=video+game+character+traits+morality turns up nothing like the present invention.

Concerning The Lord of the Rings game, an amazon.com reviewer writes, “Attaining a higher experience level gives you one skill point to spend on magical attacks and defenses, and five attribute points that you can distribute how you wish among attributes such as courage, strength, health, defense and accuracy,” at http://www.amazon.com/Electronic-Arts-14633145137-Lord-Rings/dp/B00006JLQ0. Examine the game, and you will see that there is no mention of morality, nor a moral premise, nor a moral level meter, nor of a world that is effected by the player's moral choices.

Nor is there any mention of Morality at the home site for The Matrix:
http://thematrixonline.station.sony.com/game_basics.vm
As in any MMO, a redpill's goal is to increase their experience. There are many ways to do this, some of them faster than others. Dependant upon a redpill's preference and strategy, each method of advancement will have different advantages. The most common ways to increase one's experience is to defeat enemies or complete missions, but you can also gain valuable experience by finding Access Nodes, successfully performing crafting actions, tapping Data Nodes, and a multitude of other activities unique to The Matrix Online. Once a redpill has gained enough experience, they will gain a capacity for greater Health, Inner Strength, Memory Capacity and additional Attribute Points to distribute at the redpill's discretion.
This increase allows a redpill to level up their abilities. Many Abilities, like Awakened, become incrementally more powerful as they increase in level, while others must be combined with other Abilities before they can be loaded. Increases in experience require the budgeting of $information to assure that one's Abilities are an effective addition to their personal arsenal.
Redpills are given the opportunity to raise their Attribute Levels as levels are gained. This is a critical.
http://thematrixonline.station.sony.com/game basics.vm

Although players have a “respect level” in The Godfather Game, the game has no “morality level.” Nor does Grand Theft Auto nor Harry Potter nor any other game in the prior art have a “morality level.”

Never has any video game incorporated a “moral level” for a character. The incorporation of a “moral level,” along with other entities—such as a moral premise—disclosed throughout this present invention, would allow for improved video games endowed with enhanced methods of storytelling and deeper emotional involvement. The present invention would allow for a revolutionary new generation of video games.

On the back of the 2007 Game Writing: Narrative Skills for Videogames, it is written: “As computer games become more and more like Hollywood productions, the need for good story line increases.” This appears to be a typo—it should read, as Hollywood productions become more and more like computer games, the need for good story increases.

While all classic stories represent the vision of an individual, from Shakespeare's Hamlet, to Homer's Odyssey, to Dante's Inferno, to Tolkien's Lord of The Rings, modern movies and video games create “story by committee.” They either tag story on as a complete afterthought, using Joseph Campbell's classic structure, but robbing the skeleton of a heart and soul via the way of a central moral premise, so that it never quite lives. Or they hire a group of “writers” armed with story outlines from a Robert Mckee seminar, to add corny dialogue, knowing full-well that the teenage boys aren't interested in everlasting art, but only in shooting things. As the words “story” and “cinematic” are used in PR hype by vast corporations, the words become redefined in a postmodern context wherein story is robbed of its classical, immortal sense. Everyone calls the dumbed-down, primitive dialogue “story,” they pat themselves on the back, and believe they have achieved Shakespeare.

The present Game Engine renders a game with classic, immortal storytelling, thus allowing that game to achieve the level of immortal art. FURTHER PRIOR ART AND OBJECTS AND ADVANTAGES OVER PRIOR ART

This present invention—The Beatrice Game Engine-takes gaming to a brand new level via its numerous objects and advantage. The Beatrice Game Engine fosters deeper emotional involvement by providing an underlying moral framework within which meaningful stories can unfold. Story is nothing without character, and character is nothing without ideals, and ideals cannot exist without absolute moral standards. So it is that the BGE imposes absolute moral standards in the context of a video game, so as to achieve deeper, unprecedented, superior gameplay.

While storytelling in video games has been attempted, there is wide-ranging agreement amongst experts, as elaborated on later on in this patent application, that storytelling in video games has consistently fallen short of storytelling in other mediums including books and movies. This patent argues that storytelling in video games can be every bit as profound, if video games learn to incorporate the fundamentals that make storytelling profound in classical literature and film—the poetry of higher moral constructs. The BGE accomplishes this.

The Beatrice Game Engine described in the present invention is novel and useful in that it solves the problem of storytelling by imposing a context of higher moral standards on game environments and characters. The BGE is novel and useful in that by enriching gameplay with storytelling and a moral context, it vastly expands the video game market. Video game companies that incorporate the BGE will stand head and shoulders above the rest, as not only will the BGE attract more players with richer, more meaningful gameplay, but it also will appeal to parents, educators, and moral leaders who can get the word out.

Furthermore, the Beatrice Game Engine will allow video games to become everlasting art. No classics are buoyed over time without classical story deriving from higher moral principles, and a unifying moral premise.

John Milus, the academy award nominated screenwriter of Apocalypse Now and Magnum Force (in which Clint Eastwood reminded the porno MFA/MBAs “a man's gotta know his limitations”) had this to say in Harpers:
(John Milius) subsided for a moment and then resumed, somewhat mysteriously at first. “Homer,” he pronounced. “Homer. Can you believe what those assholes did to him with that film Troy? Completely embarrassing. Me and my kid, we wanted to take a DVD of the thing, tie it by a cable to our car's bumper, and drag it up and down Hollywood boulevard.” He fell silent for a moment. “Hollywood . . . The only thing I can think of remotely as horrible as war; there are stories, things I have seen in that town that, believe me, I would never tell anyone.”—Valkyries Over Iraq, The Trouble with War Movies, by Lawrnece Weshler, interviewing John Milius in November 2005 Harpers Magazine, academy-award nominated writer of Apocalypse Now, Clint Eastwood's Dirty Harry, Magnum Force, and Electronic Arts' video game Medal of Honor.

This present invention—The Beatrice Game Engine—is novel in that it counters commonly held conceptions held by gaming experts and postmodern Hollywood moguls regarding the gaming industry. The general consensus of gaming experts is that God and morality are irrelevant when it comes to video games. The consensus is that God and the Judeo Christian morality provides a barrier to the freedom that is required to create open-ended and “fun” games such as Grand Theft Auto and Gears of War. The general consensus of the gaming industry is reflected in their games, and within quotes and excerpts from gaming experts throughout this document, as well as within the following letter which was printed in gaming magazine and which was given a “standing ovation” in the editor's response:
LETTER OF THE MONTH/PLAYBACK/PLAY MAGAZINE/OCTOBER 2005
I share your anguish at Hillary 's comments, but I'm not surprised by them. Since I have more gray hair than you (as good as excuse as any), let me explain how I think all this came to be.
Our country was founded by Pilgrims after they left Holland and got backing from the Virginia Company in England for the voyage over here. According to them, they left Europe because of the teaching of their Puritan brand of religion. The real reason was probably the Europeans kicked them out because they were a bunch of whacked-out nut-case. You may think this judgment is over severe, but I think most professionals today would agree that the Puritan Religion, a religion that preaches that pain and suffering are good and pleasure bad, is both dangerous and psychologically harmful. The Puritans thought that pleasure is something you enjoy in Heaven, not on earth. And boy, were they ever true to their religion. Remember, these were the wonderful people that slaughtered almost all the people of the nations of North America and put people to death for having sex before marriage.
One might ask why echoes of such terrible ideas still live in American society today. Well, it might have something to do with the fact that the church has access to our children before they reach the age of critical thinking. It might have something to do with the fact that religion is used as a political tool in this country while maintaining a non-political status.
Thomas Jefferson wrote about the dangers of mixing religion and politics, and as he so eloquently put it:
“Believing with you that religion is a matter which lies solely between man & his god, that he owes account to none other for his faith or his worship, that the legitimate powers of government reach actions only, and not opinions, I contemplate with sovereign reverence that act of the whole American people which declared their legislature should make no law respecting an establishment of religion, or prohibiting the free exercise thereof thus building a wall of separation between church and state. ”
Therefore, one might argue that Hillary 's political comments advocating repression of sex in video games, which are based on religion-derived puritan ethics, are not in the spirit of the American Consitutionas envisioned by our founding fathers, since they effectively dissolve the separation between church and state given that she iv a candidate for the President of the United States.
Cheers, Henry.
PLAY MAGAZINE'S RESPONSE: We only regret that you weren't here to receive your standing ovation.

While AI has been incorporated in video game characters, it has fallen short of its full potential by disregarding a higher morality and the classical aesthetics found within the Great Books. And while some might argue that morality has been attempted, it has fallen short because of the commonly held opinion that morality is relative. But as Einstein himself noted, morality does not arise by everyone making up their own rules, but it descends from higher ever-fixed absolutes. Moral premises are governed by Natural Law:
The highest aspirations and judgments are given to us in the Jewish-Christian religious tradition. It is a very high goal which, with our weak powers, we can reach only very inadequately, but which gives us a sure foundation to our aspirations and valuations. If one were to take the goal out of its religious form and look purely at its human side, one might state it perhaps thus: free and responsible development of the individual, so that he may place his powers freely and gladly in the service of all mankind.—Albert Einstein

So it is that the present invention would offer a deeper gameplay experience by adhering to Einstein's view of the universe. And in doin so, it also adhere's to William Wallace's view of the universe, when he talks about storing up treasures where rust and moth cannot corrupt them, in Braveheart: “You're so concerned with squabbling for the scraps from Longshank's table that you've missed your God-given right to something better. There is a difference between us. You think the people of this country exist to provide you with position. I think your position exists to provide those people with freedom. And I go to make sure that they have it.”

Imagine a video game character that would choose danger and death and freedom, based on a moral premise, over mere power and gore. Such a video game character would tell a deeper, everlasting story-something far more noble than al that is reflected in fleeting action, as echoed by Einstein:
Somebody who reads only newspapers and at best books of contemporary authors looks to me like an extremely near-sighted person who scorns eyeglasses. He is completely dependent upon the prejudices and fashions of his times, since he never gets to see or hear anything else. And what a person thinks on his own without being stimulated by the thoughts and experiences of other people is even in the best case rather paltry and monotonous. There are only a few enlightened people with a lucid mind and style and with good taste within a century. What has been preserved of their work belongs among the most precious possessions of mankind. We owe it to a few writers of antiquity that the people of the Middle Ages could slowly extricate themselves from the superstitions and ignorance that had darkened life for more than half a millennium. Nothing is more needed to overcome the modernist's snobbishness.—Albert Einstein

The Beatrice Game Engine, by treating morality as something everlasting and fixed that is contained within the eternal art of the Western Canon, rises above all previous attempts in creating a superior game with rich storytelling and deeper emotional involvement.

Within the Beatrice Game Engine, every character, whether controlled by people or by AI, has a moral level tied intrinsically to the Ten Commandments, the Judeo Christian Heritage, and noble literature such as Dante's Inferno. For morality is only made apparent via stories and myths, and in order to render a living morality, the video game must first render a living story.

As Moore's law marches on, allowing game designers to render video games with ever-more-realistic physics, a great need and opportunity emerges for innovative companies to create new paradigms in gaming so as to differentiate themselves. The BGE offers a new innovation that fosters deeper gameplay and successful storytelling.

The prior art of games such as Prey falls short:
I'm not sure who came up with the whole Indians vs. aliens theme of the game, but the story in Prey is paper thin, and Tommy is one of the most unlikable anti-hero characters I've seen in a long time. Luckily all of this is irrelevant, as the action is truly the centerpiece of this game and—while it lasts—it's pretty damn fun.
In the end Prey is a pretty coolfirst-person shooter, with a forgettable story and characters. The gameplay mechanics in Prey, while very interesting, weren't utilized as much as they could have been, and multiplayer is a little lighter (albeit fun) than we expected.

In addition, the present invention allows for more exalted female characters—a long felt need of many in the industry. Furthermore, the present invention would also attract more women to the video gaming enterprise. In the November issue of GamePro, a writer writes, “Taking Women in Games Seriously. I can't help but be put off by the misuse of women in video games: In almost every game, female characters look like they belong in fashion magazines and adult films, and not in a war zone or an adventure/combat setting. Most of them wear miniskirts, tiny shorts, or microscopic bikinis; have long gorgeous hair; and sport super-model physiques.

Through no fault of their own, women have become commodities in video games, rather than characters to be taken seriously as heroines (or villains). Almost every woman in a video game looks like they're dressed for the beach or a hot night out, and the enjoyment from competent storytelling is diminished in favor of cheap attempts to grab attention . . . The current trend of turning heroines into shallow objects of sexual desire is neither needed nor warranted. The game industry is maturing and finally being taken seriously by the entertainment industry in general. This is a great opportunity to enable games to be recognized as storytelling masterpieces on par with film and stage. Game developers need to stop degrading impeccably crafted works with gratuitous sexuality: There is already plenty of that to go around everywhere else.”-Fernando Garcia, GamePro, #206, November 2006, Letters-Via Internet

Gamepro Response: Although gratuitous sexuality will probably always be a part of popular entertainment, the maturing of the gameplaying audience will cause game designers to think more deeply about the images and roles women play in their games.

This present invention and the BGE take the above Gamepro response one step further. The deep, profound, exalted woman character will naturally emerge when the BGE is incorporated into gaming environments, as the BGE will provide characters with something higher to live for—a moral premise. Just as Beatrice in Dante's Inferno, women will come to symbolize purity in intent and deed, and men will seek to behave morally to rise to the women's standards in the context of the present invention. Chivalry will be reborn.

Thus this present invention offers a method for creating a better gaming experience, deeper gameplay, more meaningful games, deeper emotional involvement, memorable characters, enhanced education, and more profitable gaming franchises.
“A lot of games feel ready soulless and heartless to me. ”—nave Jaffe, Creative Director, Sony Santa Monica Studios, in GameInformer #150, The World's #1 Computer & Video Game Magazine
“Chris Crawford, one of the most important figures in the history of computer gaming, and one of the few articulate thinkers about game design as a art, says that games will never come of age until they can induce in players the same depth of emotion as a well-told story. Indeed, Crawford abandoned game design in favor of the creation of what he calls the Erasmatron, an engine for creating interactive stories. He left the game industry because he believes that industry pressures have made it virtually impossible to develop worthwhile and meaningful games. Indeed, Crawford now seemingly doubts the very possibility that gaming can ever become a true artform.”—Greg Costikyan, game designer, http://www.costik.com/gamnstry.html: Greg Costikyan has designed 27 commercially published board, roleplaying, computer, and online games. He writes frequently about games, game design, and game industry business issues for the New York Times, Wall Street Journal Interactive, Salon, and other publications. He is Co-Founder and Chief Design Officer of Unplugged Games, a venture capital start-up to develop and deploy games for Internet-enabled cellphones and other wireless devices.

This present invention solves many commonly recognized problems in the gaming industry, while also creating new uses for video games, such as education and moral education, as well as creating vast new markets for gaming.

### MORE PRIOR ART & EXPERT OPINIONS

It is widely acknowledged throughout the literature and elsewhere that video games are missing the elements of classical storytelling—that video games are lacking soul and substance, and that video games are failing to become an art form. On the back of the 2007 book: Game Writing: Narrative Skills for Videogames, edited by Chris Bateman, it is written, “Research shows that stories are highly valued by game players, so today's studios and developers need good writer. Creating narrative—a traditionally static form—for game is a major challenge.”

So have the multi-billion-dollar conglomerate creators of games arisen to this task of creating deeper narrative in games? The answer is no, as the prior art games and the quotes from experts in this document will demonstrate. The research that reveals consumers are interested in immersive plot, character and storytelling has for the most part merely lend companies to augment the hype surrounding video games. Incapable of creating classic storytelling, they hype “cinematic storytelling” as never before, sending marching orders and press releases out to all the fanboy game reviewers, who trumpet them far and wide, proclaiming “deeper story, engaging storylines,” and more . . . and still . . . no story. Despite the hype from the marketing departments, games yet lack classic, everlasting story, because there is no classic, everlasting soul nor morality nor moral premises in modern video games, as there was in Dante's Inferno and Homer's Odyssey. Furthermore, there is no “moral level meter” in contemporary vide games. In the preface of Game Writing: Narrative Skills for Videogames, edited by Chris Bateman, the following is stated:
Additionally, games are difficult to adequately compare to other media, primarily due to their interactive nature. Whereas the concept of genre has a clear meaning in the context of a novel or a film, it is less clear in the context of a game. Games with narrative elements represent genre in a multidimensional manner because they consist of a narrative gene on the one hand and a gameplay genre on the other. xxvi—preface, Game Writing: Narrative Skills for Videogames, edited by Chris Bateman

Note the book, penned by experts, mentions narrative, but nowhere does it mention morality nor a moral premise, both of which are essential to deeper, everlasting story. Indeed, the moral premise is the seed from which the Oak of Joseph Campbell's Hero's Journey naturally grows. Nor does the book mention a “morality level meter” anywhere throughout its pages.

In the preface of Game Writing: Narrative Skills for Videogames, edited by Chris Bateman, the following is stated:
The problem has been the lack of clear examples of great game narratives. Although people who work in games have many examples they like to cite, these fall somewhat below the highest standards of work in other media—perhaps this is only to be expected in such a young medium. The problem in this regard is that we have yet to solve even a fraction of the key issues in game design, and this limits the kind of stories that can be told. We can tell a great monster story, and we can tell a heroic quest story quite well too, but the essential tension between the freedom of the player and the constraints of narrative places a severe limit on what can be achieved at the present time. This is not to say there are some hugely talented people working on game narratives. Rather, it means that the best that we have achieved thus far can only really he appreciated in comparison to other games; whereas narrative comparisons to the best novels, films, and plays often leaves games seeming slightly deficient. xxvi—preface

Note the book, penned by experts, acknowledges the lack of successful game narratives, but nowhere does it mention the present invention's solution-morality, a moral premise, and a “moral level meter.” The book states, “We can tell a great monster story, and we can tell a heroic quest story quite well too, but the essential tension between the freedom of the player and the constraints of narrative places a severe limit on what can be achieved at the present time.” The “limit” lies in the failure of the prior art to incorporate the moral premise and morality into the BGE. Nowhere does the present invention mention morality, nor a moral premise, nor a “morality level meter.”
A severe problem in this regard is the absence of a stable and supported underground game development community. Without a framework to support “art house games, artistic freedom is lacking. When the vast majority of games (and certainly any that are developed on a reasonable budget) are purely intended for entertainment, it is hard for the artistic aspects of game narrative to be fully explored. Just as underground films drive innovation and creativity in the movie industry, so, too, we need a similar engine of artistry for games. xxvii—preface, Game Writing: Narrative Skills for Videogames

Indeed, the UT2007 engine, when incorporated with this present invention, will result in a rocking game. Indie video game creators will blossom and excel as the tools become better, with drag & drop interfaces, such as Final Cut Pro, Premiere, Flash, Photoshop, Autocad, and other design tools. The present invention adds a concept that is small in cost to overall game development, but revolutionary in scope.
Despite these problems, there are still hundreds of game writers working in the field of video games, all of whom are trying to do the best job they can under severe and sometimes restrictive limitations. There is much to praise in their achievements, especially when placed against the context of unraveling the Gordian knot of presenting narrative—traditionally a static form—via games, which are at their heart dynamic, interactive systems. The incompatibility here seems irreconcilable; the fact that we have any game stories of any quality at all is testament to the skill and creativity of pioneers in a largely unrecognized field. xxvii—preface . . . It cannot be overstressed that whereas the narrative language of theatre, novels, films, and television has become largely codified and consensual agreed, the narrative language of games is still very much in a state of evolutionary flux. We do not know what the initial narrative language of games will be like—likely we will not know until all the technology pertinent to games has been developed, and this could take decades or even centuries. Therefore, everyone working in the field of game writing strives toward an ideal that lies somewhere beyond the horizon.—Game Writing: Narrative Skills for Videogame, edited by Chris Bateman

The above book, penned by experts, admits, “We do not know what the initial narrative language of games will be like-likely we will not know until all the technology pertinent to games has been developed, and this could take decades or even centuries.” The present invention does know what the narrative language of games will be like—it will be the same as all classical, everlasting literature—if all classical, everlasting books, movies and more—the narrative language will be founded upon morality and a moral premise. Thus this invention delivers the holy grail of the video game industry, and it takes the current video game industry beyond the horizon.

On the back of Game Writing: Narrative Skills for Videogames, it is written:
“As computer games become more and more like Hollywood productions, the need for good story line increases.” This appears to be a typo—it should read, as Hollywood productions become more and more like computer games, the need for good story increases. Research shows that stories are highly valued by game players, so today's studios and developers need good writer. Creating narrative—a traditionally static form—for game is a major challenge.—Back of Game Writing: Narrative Skills for Videogames

Anyone who has read Dante's Inferno or seen Braveheart or Lord of The rings and says that narrative is a “static form” has yet to understand the exalting dynamics of literature. For the classics have moved, and continue to move, far more souls than present video games ever have. The present invention will allow deeper action and exaltation to occur.

So what have the solutions been to all the pronounced need for story in video games? Have corporations incorporated richer storytelling? Or have they just turned up the hype machines, as illustrated in the following post from a gearhead:
From: http://www.gearheadsofwar.com/story/2006/8/31/203410/967
More Interaction
I think a feature I havent really seen done verywell is interaction. Oblivion advertised it but never came through, I think a game this generation that will do a good job with this is Mass Effect.
I want a game, where I create a person, and every person I talk (dont talk) to effects how my character's life runs. I know its kinda hard to imagine hardware powerful enough, but I think the generation after this will possible be able to handle it.
My idea is kinda hard to explain but I think you catch me drift.
As far as games today go, I just want to see more depth into the plot. Many different characters and environments the change drastically (unreal was one of the first games that exceeded with this idea.) But honestly, I love my generic WW2 shooters as well so I guess I am not very picky anyway.
by Zoso Fan on Thu Aug. 31, 2006 at 10:01:56 PM EST
http://www.gearheadsofwar.com/story/2006/8/31/203410/967

Gears of War promises at: http://www.templegames.co.uk/Xbox-360/Games/Gears-of-War.asp
Gears of War unites next-generation technology with classic, emotional storytelling and a revolutionary tactical combat system, engrossing the gamer in a horrifying epic story of war and survival.:
Engaging and disturbing cinematic story—Massively scoped worlds, memorable characters and an epic story line play out like an intense and unsettling blockbuster action film. Dramatic in-game camera work and a compelling story bring the brutal, emotionally charged experience to life. Gamers control Marcus Fenix and his fire team as they pit advanced human technology against the overwhelming and horrific Locust Horde.

It remains to be seen if they deliver a deeper, more emotionally involving game, but without the rich context of Einstein's favored Judeo Christian and classical heritage that buoyed Dante's Inferno and Hamlet, it is hard to believe they will achieve this.
http//www.gamersreports.com/news/3320 reports:
Developed by Epic Games Inc. and published by Microsoft Game Studios, “Gears of War” tells the harrowing story of mankind's struggle against the monstrous Locust Horde through stunning high-definition graphics and an intense storyline on the scale of a blockbuster movie.
http://www.gamersreports.com/news/3320
Some chalk this us as just Microsoft PR to diminish the Sony PS's launch:
An obvious attempt to . . . well, let's say “hinder” the PS3's launch. And yes, like many people have said, this will in no way affect the PS3 (as much as Microsoft want it to). Where's my Halo 3, Mr. Gates?;) At least, if I can't get my hands on a PS3, I'll have this to fall back on. Let's hope it'll live up to the hype.—Written by Itaintrite on 2006/08/03: http://www.gamersreports.com/news/3320

Indeed, although Microsoft is hyping Gears of War as “uniting next-generation technology with classic, emotional storytelling and a revolutionary tactical combat system, engrossing the gamer in a horrifying epic story of war and survival,” the lead designer of Gears of War, CliffyB, reveals the true nature of Gears of War in an interview at Gamasupra.com that is also shared at Gamedev.net:
In that sense, then yes what you described is fundamentally the same. I guess I'm just used to reading things from writer who when they mention things like “enforcing the story”, they mean forcing the player to follow the rails that lead them into the story the writer wants to tell, such as in that Deus Ex example.
As an example of what I mean, here's a snippet from an interview with Cliff Bleszinski from Epic Games which I read at Gamasutra yesterday:
Quote: (Cliff begins to demonstrate Gears Of War, and an NPC emerges to show the main characters into a safe building)
GS: Can you shoot that guy?
CB: We're still figuring that out.
GS: What's the choice there?
CB: Well, he's going to help you out by offering you some items, and potential weapon upgrades. And if you kill him, you won't get that opportunity.
GS: But is it a moral choice as to whether you can kill him?
CB: No, we're not making Knights Of The Old Republic or anything here. Who these characters are is largely pre-defined, as far as Marcus being an anti-hero, and Dom being his buddy. Part of it is just my own game design philosophy because, for me, whenever I play those games, I always go evil. And I have a feeling that if they made those games, if you could only choose the dark path, and you only thought you could choose the light path, nobody would notice, because it seems to me that everyone who goes for the Force chokes.
You can't shoot Dom [in Gears Of War] either. The fundamental problem with making an interactive narrative is like—how would you make Lethal Weapon 2, the buddy cop movie—if in the first scene Danny Glover turns to Mel Gibson and shoots him in the head? Never underestimate the ability of the user to undermine the narrative you're trying to tell. You have to allow for every single scenario. You're empowering the user's ability to make the game look stupid, essentially.
It's stuff like that (particularly the last paragraph) that I'm used to reading from game writers; for some writers it's more about forcing the player to experience their linear narrative than providing an interactive experience. I think that's the wrong philosophy to take for interactive stories. (added by Trapper Zoid GDNet+), http://www.gamedev.net/community/forums/topic.asp?topic_id=352853 &PageSize=25&WlichPage=2

The Beatrice Game Engine in the present invention would allow free will, and it would allow the user to choose between the moral and immoral. Indeed, such choices between the moral and the immoral would be plot points via which a profound and deep story would evolve. Furthermore, the Gods and Angels in the environment would interact with the player based on their moral choices. Virtue will win the day, and vice will lose the day.

Shacknews carried the following interview with CliffyB:
http://www.shacknews.com/extras/2006/091506_cliffyb_{—}1.x
Shack: What's your preference for storytelling in games: scripted events that still allow you to run around and do stuff, or cinematics, which force you to sit still and watch? Why?
CliffyB: Storytelling in the interactive realm is based on a series of tradeoffs. If one chooses first person the entire time then the player may feel more immersed but that immersion can easily be messed with by shooting other characters or jumping around like an idiot while they're speaking to you. Cutscenes are a more deliberate way of advancing story but when you're playing a game you'd rather actually play rather than watch a movie.
Gears uses a combination of techniques. We had a priority for these; the ideal way was to always tell story when the player was moving in the world (BTW, this is usually the cheapest way to do it.) The next fall back was to use seamless camera moves while you were playing along with points of interest (Basically, hold Y to see cool stuff.) Finally, we use the occasional (brief) cutscene to inform the player of critical data.
Shack: What do you feel is the best way to relay an emotion (anger, sadness, whatever) through video games to the player? Should emotion even be considered when developing a game?
CliffyB: When you're playing a game you have a captive audience for hours on end. It's possible through careful and intended manipulation of the player to get an emotional response. The easiest is empowerment—feeling like a badass. Fear and anxiety are behind that. Sadness and empathy are the hardest emotions to pull out of your average gamer.
Shack: What games have provoked the most emotion from you?
CliffyB: I was rather saddened by oldschool RPG games. Lunar got to me. Phantasy Star 2 saddened me when Nei was killed by Neifirst. But as I grew older and my anime RPG fetish wore off I realized that for your average person it's going to take a hell of a lot more. That's the million dollar question—can a game make you cry? And everyone in the biz is wrestling with it.—http://www.shacknews.com/extras/2006/091506_cliffyb_{—}1.x

Note again that there is no mention of the classics-neither of Dante's Inferno nor The Odyssey, nor The Bible, when discussing story and storytelling. Nor is there any mention of a Moral Premise. Perhaps those who designed games and made vastly successful games in the era where games were not an art form are not the best suited to create eternal art in the realm of video games. So it is that Pagan art flourished throughout Europe, but until the advent of Christianity, there was no Sistine Chapel, nor Hamlet, nor Dante's Inferno, nor everlasting art, but for The Odyssey and The Iliad which only lived and endured and achieved art by encompassing the highest codes of morality. So it is that it is curious that game designers talk about story without mentioning myth and morality. But then it is not curious that games have not equaled The Odyssey in terms of art, which uses technology over 2700 years old, and which is far more capable of telling profound stories than modern video games.
I liken myself to a successful outlaw. To be worth a s--- in the world, you've got to blaze your own trail. Nothing else is any good. Whatever you're going to do, you're going to do alone.—John Milius, (Apocalypse Now, Dirty Harry)

Mike Medavoy says, “The average studio now has thirty people doing story notes, twenty people playing producer (and taking screen credit for it too), and focus groups composed of disaffected Generation Xers causing entire films to be reedited into cookie-cutter models.” The famous screenwriter Joe Esterhaus said that the quality of a screenplay declines in a manner directly proportional to the number of writers who work on it.

And so too are video game scripts written and re-written by numerous writers. They try to make up for the lack of the fundamental idea of a moral premise disclosed within this invention with a team of writers.

The present invention will allow for a single author or artist to write the script for the video game and endow it with a central, unifying moral premise, and the “morality meter” and Beatrice Game Engine AI will allow the story to come to life. The present invention will work best in the hands of companies that respect classic storytelling. The present invention will greatly simplify the art of storytelling in video games, as it will base the art upon a moral premise and a moral level meter, and thus allow simple moral premises to provide initial conditions that provide the greater story. Without the method for augmenting and decrementing the moral level meter in this present invention, the prior art had to resort to conceiving of all possible stories based on character choices. By introducing the moral premise algorithm into a video game, storytelling is greatly simplified in the realm of games, and single individuals are better able to render their visions, worlds, and stories.

Throughout the prior art in video games, story is often tagged on as an afterthought by a fleet of “story experts.” It is as if Shakespeare came up with the idea of Hamlet, but then hired a team of MBA/MFA professionals to flesh it out. It is as if Dante came up with the idea of the Inferno, sold the logline to Microsoft, and then they hired a team of story writers to impose a Joseph Campbell outline upon the poem. It is as if Homer conceived of The Odyssey, but then brought in a team of game writers to write some corny dialogue so that Microsoft could take on the Playstation 3 with “cinematic storytelling.” That is how the video game currently treats story, and that is why the video game industry needs the present invention to achieve their long sought-after goal of endowing games with story.

The hallmark of all everlasting art is the divine imprint of the individual, and to the degree that video gamedesign companies forget this, they will never achieve higher, lasting art. The present invention calls upon video game companies to study great works of literature and respect great writers, so that they can then endow their video games with the simple moral premise, by which the moral meter can be augmented or decremented, based upon the character's actions.

Shacknews goes on to report:

Shack: Is story an important element in Gears of War? Tell us more about it: who wrote it, how did you meet the head writer, et cetera.
CliffyB: Story is yet another potential motivator that we as game designers can use as a carrot to get the user to play just one . . . more . . . level. Why not leverage that? The writing team was comprised of Eric Nylund and Susan O'Conner. We worked together to make sure that you gave a damn about the humans in this universe.

Somehow they did this without introducing a moral level meter or the idea of the moral premise.
Shack: How interactive are the environments in Gears of War? Please provide an example or two of what the player can do.
CliffyB: I like our destroyable cover, especially in versus. When your foe takes cover behind a couch and you tear it to shreds with your lancer and he suddenly finds himself standing there, feeling naked, and you cut him down by popping his head with a well placed sniper shot . . . that's pure and beautiful.

So it is that an interactive environment is defined by destroyable environments, rather than other in-game players who interact based on moral premises. So it is that an interactive environment is defined by destroyable environments, rather than gods and angels; and demons and devils, who can interact with the players in a moral, meaningful manner, based on a moral premise, as described within the present invention—which results in epic storytelling. The Shack interview continues:
Shack: Tell us about other multiplayer elements in Gears of War: what's available, how the modes work, etc.
CliffyB: Gears of War is truly a team-oriented game. As a result, we have placed increased emphasis on cooperative multiplayer—success cannot be achieved by going at it alone. Players who decide to put on a headband and do their best “Rambo” impersonation will be cut down in short order. It's all about working as one well-oiled machine and we will be rewarding those who decide to work together. We're also working hard to blend together the single and multiplayer aspects of the game. You'll have to wait until the final product to see what we're talking about but we're certain that you'll be blown away. Let's just say that we're giving you yet another compelling reason to join the millions of Xbox Live subscribers.
Shack: Any particular reason you went with a third-person view over first-person?
CliffyB: I love first person, don't get me wrong, but it just felt wrong for this game. It's so cover based; but what does taking cover mean in first person? I feel like a five year old who was told to stand in the corner when I take cover in that view. I like seeing my character on screen as long as the camera is consistent and fair and then, by holding LT, you're damned near in first person view when aiming. So I believe that we have the best of both worlds in Gears.
Shack: What has gone into making Gears of War a cinematic experience?
CliffyB: Beyond the music and nice (but short!) cutscenes it's all about the in-game camera. When you're just playing it looks cinematic because we've put a ton of work into the in-game camera. Every bit of its positioning and movement has been labored over for months on end and the end result is something that looks like some sort of Sci Fi CNN.
Shack: Like any Epic game, Gears of War is riding quite the tidal wave of hype. How do you feel about that?
CliffyB: A little scared and a whole giant bunch of excited.
Shack: Have you ever reached a point where you say to yourself, “I'm CliffyB; my games will deliver, ALWAYS?”
CliffyB: No, because that's the point when I start believing my own bullshit and start to screw up.
Gears of War will be released this November for Xbox 360.
From shacknews: http://www.shacknews.com/extras/2006/091506_{—ciffyb}_{—}1.x

Again, there is much talk of “storytelling,” but no mention of morality. There is much talk of “cinematics” but no talk of what makes all “cinematics” immortal art and cinematic—a moral premise. Morality, a moral premise, and a moral level meter could go a long way in enhancing and exalting game play, resulting in new and unexpected video games.

The beauty of every single classic, from Hamlet, to Moby Dick, to Dante's Inferno, to The Odyssey, is that the center and circumference is the contemplation and manifestation of morality. This present invention will afford a superior level of game play with exalted storytelling, allowing the player's soul to be manifested on the screen and throughout the game's beginning, middle, and end. The player will become either a hero or villain, and they will receive their just reward. Thus this present invention will afford a new realm of games.
“The first attempts to make movies into real stories failed. They failed because they were conceived as filmed plays. A camera would be set up about where an audience member would sit in the middle of a theater, and the play would ensue. It didn't work. Early film makers didn't take into account that the human eye wanders all over the fixed box of the stage during a play, and a camera that does any less will bore the film audience to tears. They also hand discovered the rich tool set of camera angles, close-ups, far shots, and all the language of film we now take for granted. Generally speaking, they hadn't discovered what this particular story form was good at. And frankly, neither have we in games.—http://gamasupra.com/features/20050727/sutherland_{—}01.shtml—John Sutherland, What Every Game Developer Needs to Know about Story, John Sutherland is a writer at Microsoft Game Studios. He has done a variety of writing, script doctoring, and story consultant work on Dungeon Siege II, MechAssault 2, the entire Combat Flight Simulator series, Mythica, and dozens of other games, shipped, cancelled, or forthcoming. Few people know that he is the author of all the haiku in the strategy section of Go in the card and board games area of Zone.com.

This invention capitalizes on the fact that hitherto game designers and experts in the gaming industry have missed out on the fact that morality lies at the center and circumference of classical storytelling, and thus in order for games to achieve the elusive benefits of storytelling, they must root themselves deeply within a moral context. The subtle or prominent introduction of the “moral level meter” in the present invention will allow video games to achieve a deeper and higher degree of storytelling. The presence of the moral AI described within this invention can go a long ways in fostering deeper game play via the introduction of epic storytelling.

Moral contexts based on classic mythologies have throughout history demonstrated a superior tendency to foster freedom and happiness, and so too will games composed in classical, mythological contexts achieve a superiority over games composed without the sublime context. The center and circumference of all higher mythological contexts is morality, for there can be no epic story without heroic actions based upon a transcendent morality. The introduction of a moral dimension to video games, via a moral meter, soul meter, spirit meter, or other means, will foster a superiority in the realm of epic storytelling, more immersive game play, lasting brands, deeper emotional involvement, augmented markets, and increased interest and approval from parents and educators. Such superiority will translate into hitherto unseen superior game play, superior sales, and superior long-term brands. This present invention will foster novel opportunities for old and present games, and brand new opportunities for games that have yet to be conceived and created.

Expert panels of game developers, as discussed in detail later in this application, have widely agreed that so far games have failed to marry storytelling to game play in a meaningful, deep, or profound manner. The experts feel that this failure has resulted in a limited audience, and cheap, superficial, typical thrills instead of deeper, enlightening, artistic entertainment. Many experts feel that instead of exalted story, the prior art in video games has relied on decline, decadence, and spectacle. This present invention offers the solution to a problem as old as the video game industry. Thus this invention will provide a sizable advantage to the crowded field of video games, and thus this present invention is useful, novel, and nonobvious.

Indeed the successful, profound marriage of storytelling to gameplay is considered to be a Holy Grail by the leading experts. This invention realizes this Holy Grail.

The present invention serves the need for a new type of video game. The Christian Science Monitor reports:
Video-game industry mulls over the future beyond shoot-'em-ups By Gloria Goodale | Staff writer of The Christian Science Monitor http://www.csmonitor.com/2005/0603/p11s01-stct.html?s=widep
“We need games with better stories, more interesting and complex characters; games that keep you up at night wrestling with whether you made the right ethical or moral choices,” says Doug Lowenstein, president of the Entertainment Software Association (ESA). http://www.csmonitor.com/2005/0603/p11s01-stct.html?s=widep
The present invention achieves the above.
Take a walk through the industry's annual trade show known as E3, which ended in May, and it's obvious that much of the serious development money goes for games based on movies (“Harry Potter,” “King Kong,” “Spider-man,” to name a few); sequels to popular franchises (“Final Fantasy XII,” “Sims 2,” “Halo 2”); and knockoffs of the most popular genres—fantasy and war games . . . Much like the film industry, an overemphasis on blockbusters is one of the industry's biggest weaknesses as far as encouraging innovation and creativity, say observers. “Future titles need to offer more than wild shootouts, violent explosions, and the wholesale cheapening of life,” says game designer Howard Sherman. http://www.csmonitor.com/2005/0603/p 11 s01-stct.html?s=widep

The present invention will allow a renaissance and revolution in video games by indie developers equipped with moral premises and advanced game engine such as UT 2007 and the Unreal 3 Engine.
“We've been moving in the wrong direction,” says Steve Meretsky, a designer and industry veteran, “toward bigger budgets, centralized decisionmaking by fewer big companies that has led to more licensed games [based on movies and books], and fewer experimental games.” http://www.csmonitor.com/2005/0603/p 11 s01-stct.html?s=widep

The present invention will lead both movies and video games to seek moral premises, and let them lead the development of classical stories based on Joseph Campbell's Hero's Journey.
Many of the young talents that might help create those games are also discouraged by the industry's focus on money. They say it's nearly impossible to get an audience for a new game concept, especially one with the creativity and vision of a “Sims,” the groundbreaking “God-game” (players control every aspect of their characters' lives, thus “playing God”) that revealed a largely untapped mainstream audience for social and nonviolent games. http://www.csmonitor.com/2005/0603/p11s01-stct.html?s=widep
   The present invention will force established companies to respect new ideas in the video game industry, or get left behind in the revolution. The present invention will lead both movies and video games to seek moral premises, and let them lead the development of classical stories based on Joseph Campbell's Hero's Journey, rather than tagging on the “Hero's Journey” as an afterthought.
Others point to the online communities as a hot spot for innovation, in particular “mod” games. Short for modification, mod games are variations made by fans on existing games. These underline the spontaneous creativity in the vast online communities. One of the most anticipated new titles due next year, “Spore,” the latest from Sims designer Wil Wright, capitalizes on interactive players' growing desire to customize games. Players begin as a single cell, then progress through full-blown civilizations that launch into space. http://www.csmonitor.com/2005/0603/p11s01-stct.html?s=widep Preferred embodiments of the present invention may first of all take place in mod communities, including mod communities for Valve, UT, Quake, Doom, and more. The present invention will force established companies to respect new ideas in the video game industry, or get left behind in the revolution. The present invention will lead both movies and video games to seek moral premises, and let them lead the development of classical stories based on Joseph Campbell's Hero's Journey, rather than tagging on the “Hero's Journey” as an afterthought.
Many observers agree that the online game community represents the most important social and cultural components of electronic software's future. “Online games have the potential to transform entertainment into a global-community exercise, breaking down borders, cultural and language barriers, and even political prejudices,” says ESA's Lowenstein. “I doubt any other form of entertainment holds out that promise,” he says. “We have only scratched the surface of what [interactive entertainment] can be.” http://www.csmonitor.com/2005/0603/p11 s01-stct.html?s=widep

The present invention will take gaming to a profound new level and force established companies to respect new ideas in the video game industry, or get left behind in the revolution. The present invention will lead both movies and video games to seek moral premises, and let them lead the development of classical stories based on Joseph Campbell's Hero's Journey, rather than tagging on the “Hero's Journey” as an afterthought. Monsters and Critics Reports:
http://gaming.monstersandcritics.com/news/article-1205759.php/Academy_Award_winner Jackson_to_play_games
   Academy Award winning director Peter Jackson and his screenwriting partner Fran Walsh have packed up with Microsoft Game Studios to create interactive entertainment series for the Xbox 360 and the online game Xbox Live.
   Jackson and Walsh will set up Wingnut Interactive (their production company is Wingnut productions) which will create interactive titles.
   “Microsoft has built an amazing living canvas with Xbox 360 and Xbox Live, which allows the storytellers of our time to express themselves in a new medium,” Jackson said.
   “They have fundamentally changed how people think about games. My vision, together with Microsoft Game Studios, is to push the boundaries of game development and the future of interactive entertainment.
   From a movie-maker's point of view, it is clear to me that the Xbox 360 platform is the stage where storytellers can work their craft in the same way they do today with movies and books but taking it further with interactivity.”
—From:
http://gaming.monstersandcritics.com/news/article_{—}1205759.php/Academy_Award_winner_Jackson_to_play_games

Is this more hype? Jackson says, ““Microsoft has built an amazing living canvas with Xbox 360 and Xbox Live, which allows the storytellers of our time to express themselves in a new medium,” Jackson said.”

But yet Jackson's King Kong Game received a “rotten” rating on the XBOX 360:
http://www.rottentomatoes.com/g/x360/king_kong/
“Beautiful but muddy environments, frustrating puzzles, repetitious opponents and clunky Kong controls.”
“I beat Peter Jackson's King Kong: The Official Game of the Movie that was a Remake of the Original Movie, then promptly returned it.”
http://www.rottentomatoes.com/g/x360/king kong/
http://www.amazon.com/Ubisoft-8888522812-Peter-Jacksons-King/dp/B000A0EFJC/sr=8-2/qid=1159468768/ref=pd_bbs_{—}2/104-7629271-0866362?ie=UTF8&s=videogames
=Fun=Overall
BORING, Apr. 6, 2006
Reviewer: A. Bussarakons “money” (so cal)—See all my reviews
This game is too linear and there are no options to explore. You have to follow the path that the game allows you to take with all the creativity and problem solving removed from the game play. I definitely do not recommend this game.
=Fun=Overall
not 2 great, Nov. 26, 2005
Reviewer: dan boon “dan” (PA, USA)—See all my reviews
This game let me down pretty bad, I didnt expect it to be nearly as good as call of duty 2 which is an amazing game and lived up to all the hype, but this game did look really good and the graphics looked amazing and they are, and thats about where it ends nothing else impressed me with simple shooting and puzzles so simple any 4 year old could figure them out. I just didnt have any fun with this game besides the graphics looking amazing there isnt anything else to see, you just fight the same dumb ass looking enemies including big spiders, crabs and scorpions that all look quarny as hell. And thats about it you dont even get 2 use kong much its pretty much all fps and shooting the same old enemies and only being able 2 hold one gun at a time with little ammo. Yep this game jus isnt fun its pretty lame and DEFINITELY not worth 60$. My opinion rent it or wait til its cheaper.
—http://www.amazon.com/gp/product/customer-reviews/BOOOAOEFJC/ref_{reviews/B}000A0EFJC/ref=cm_rev_next/104-7629271-0866362?ie=UTF8&customer_reviews.sort%5Fby=-SubmissionDate&n=468642&s=videogames&customer-reviews.start=11

Again and again, there are no remnants of even primitive storytelling within the world's most-hyped video games that are supposedly based on classic stories. Story is absent from King Kong. Perhaps this is because Peter Jackson is first and foremost an adapter of stories, but not a storyteller in his own right. What novels has he written? What plays has he penned? Where are his original screenplays? He remade King Kong, and he remade Lord of The Rings, and neither were as good as the originals—they only employed better special effects. So it is that spectacle comes to replace storytelling, and Aristotle spins in his grave.

The present invention respects Dante and Aristotle. It respects the Great Books and the Bible. It respects the Aristotlean three-act structure, Joseph Campbell's Hero's Journey, and the idea of the overarching moral premise via which all classic, everlasting story is born. And the present invention delivers a superior form of storytelling.

### MORE PRIOR ART E3 2005/2006

While the technology improves, the atmosphere at E3 is straight from the prehistoric era, discounting the vast improvements in our life gained by the creation of the Judeo Christian Heritage which was employed by Shakespeare and Dante to create two of the most successful literary brands of all time. Lord of the Rings and Braveheart, both academy-award winning epics, were penned by authors with deep-seated Judeo-Christian values. Einstein said,
The highest aspirations and judgments are given to us in the Jewish-Christian religious tradition. It is a very high goal which, with our weak powers, we can reach only very inadequately, but which gives us a sure foundation to our aspirations and valuations. If one were to take the goal out of its religious form and look purely at its human side, one might state it perhaps thus: free and responsible development of the individual, so that he may place his powers freely and gladly in the service of all mankind.”—Albert Einstein

Can there be any doubt then, that marrying the Judeo-Christian heritage to preferred embodiments of the present invention would endow it with a vast and superior advantage? Such is the nature of this invention.

As video games strive towards reality in visual effects, they often forgo the reality on the spiritual level. There is nothing as spooky, nor unsettling, nor creepy, as a character that looks almost perfect, but is not “quite right.” The present invention aims to endow in-game characters with realistic souls with moral premises.

When a U.S. Marine is shooting in real life, he is usually shooting for a deeper cause that is absent in video games. The degree to which a US Marine is shooting based on a moral premise is the degree to which a video game exhibits profundity and depth. For numerous reasons, many have supposed this deeper cause, or a moral premise, to be impertinent to game play, and they have neglected to design video games around moral premises. Thus this invention rebels against a commonly held prejudice, much like the Wright brother's invention rebelled against the popularly held notion that flight was impossible.

If a player could actually be made to feel like they were playing for something greater than themselves, or accomplishing some greater significance than merely winning points and chalking up kills or “frags,” then such a game would pave brand new avenues to superior gameplay and profitability.

In all prior art, including current and next-generation games such as GTA, Spore, Unreal Tournament, Doom, and World of Warcraft, the civilization does not depend upon the protagonist behaving in a moral manner. Nor does the civilization depend upon the protagonist behaving in a moral manner in accordance with the Judeo Christian Heritage. For these reasons, there is a void in the current state of the art in gameplay. This invention fills that void by marrying gameplay to reality's large picture.
“A lot of games feel really soulless and heartless to me.”—Dave Jaffe, Creative Director, Sony Santa Monica Studios, in GameInformer #150, The World's #1 Computer & Video Game Magazine

In the real world, when God is forsaken, millions die, as demonstrated in communistic and totalitarian regimes. In the real world, when taxes are raised and people trade their freedom for security, the result is social and economic decline that tends towards dictatorships. In the real world, when porn and gambling become corporate and government-sponsored enterprises, the family breaks up, the killing of the innocent in the form of abortions burgeons, and the ever-growing government seeks to replace the family unit, demanding more revenue from gambling and porn along the way. No video game yet addresses this deeper spiritual reality, and thus this invention does not exist in the prior art.
“In some respects, every game being drenched with perfect graphics will be a good thing for gamers. If every game that is supposed to look realistic looks great and they will all look fantastic, there will be little to differentiate them beyond story and gameplay. But will large publishers really now focus on innovative gameplay or daring rendering styles? If the latest round of sequels and licensed properties are any indication, innovation is far to risky to be at the top of their lists.”—THE DEVELOPER OF THE FUTURE, John Baez and Tom Fulp, Co-Founders, The Behemoth GameInformer #150, The World's #1 Computer & Video Game Magazine
   Nonobviousness

“To qualify for a patent, an invention must be nonobvious as well as novel. An invention is considered nonobvious if someone who is skilled in the particular field of the invention would view it as an unexpected or surprising development.”

http://www.nolo.coin/article.cfm/ObjectID/B1EDE764-1F7D-472B-92E4197921C56A8E/catID/FD8C060B-5DD4-4809-A53 ECCF6BBD87E32/310/FAQ/

Leading gaming experts do not see the need for a moral premise in video games. Leading game developers do not believe that the Judeo Christian Moral framework is superior to GTA and 50 Cent. Thus the rich depth that pervades the Great Books and Classics of the Western Heritage is absent in video games.

We live in a time where media moguls, creative writing teaches, directors, and writers also no longer see the need for the moral premise and morality within books, movies, and more. Thus none of them are able to string Odysseus's bow, and they and their work will never make it on home, no matter how often they are informed about the reality of creating epic myths.

This invention marries the rich heritage of the Great Books and Classics to game play.

The Great Books and Classics derive their dominant billion-dollar brands from the rich depth of their storytelling that is rooted in a higher moral context. So it is that video games could achieve dominance by adopting this hitherto unappreciated aspect of classical storytelling—the values of Athens and Jerusalem, given to us by the Greeks and the Judeo Christian prophets.

Thomas Jefferson wrote in a letter to William Canby, “Of all the systems of morality, ancient or modern, which have come under my observation, none appear to me so pure as that of Jesus.”

This invention will serve the vast and growing market of a new generation longing to teach their children morality.
http://games.kikizo.com/news/200502/020.asp reports, “film-to-game conversions are seldom any good.” This is because the nascent gaming industry has yet to employ the higher ideals of the Judeo Christian Heritage that have rendered movies classics with games. Merely branding a game with a movie's title or comic book's character often results in failure”
http://www.theinquirer.net/?article=26002
“Still, we can't help but note with a forlorn tone in our voices that the majority of movie tie—in videogames are simple, by the numbers pieces of pulp gaming spun out for maximum sales and minimum effort by publishing houses. Given what has been done with comic book type games in the past such as Freedom Force we would be sorely disappointed if the same were to happen to some of Marvels greatest assets.”
http://www.theinquirer.net/?article=26002

To date no game has employed classical storytelling techniques, nor the higher system of morality that classical storytelling necessitates. This invention is novel in that it combines classical storytelling techniques within a game. More specifically, this invention is novel because it combines higher moral precepts, namely those of the Judeo Christian Heritage, with the context of a first person shooter in set in an open-ended world. Many open-ended games concentrate on the accumulation of wealth and the completion of missions, but never mention one's moral level, echoing that moral premise of so many classic stories: “store not treasures on this earth where moth and rust corrupt, but store treasures in the heavens.” Many FPSs have been announced for the next generation boxes. They are all similar, and they won't all be successful. Whether you are playing Doom, Quake, Unreal Tournament, Gears of War, GTA, or Pariah, you are basically shooting at monsters without the presence of a deeper moral context.

This invention will take gameplay to the next level, allowing games to differentiate themselves from the look-alike, play-alike pack. Just as the Judeo-Christian religion spread throughout Europe to dwarf the pagan religions, this invention will allow its users to create games that dominate the marketplace. Just as the Judeo-Christian heritage has lasted thousands of years, this invention will allow the creation of games with long shelf lives.

While porn is a fairly successful industry, and the pornification of culture has enriched media conglomerates, over time pornography devalues the dollar and breaks up the family. And too, over time pornography is a tiny industry when compared to the Great Books and Classics. Porn is utterly forgettable, while the words of Shakespeare, Jesus, Socrates, and Dante have endured for thousands upon thousands of years. Moral precepts, like the soul, are eternal. Action, lust, and the physical are fleeting. By endowing games with a moral premise, this game takes games to a new, profound level.

The gaming industry, located in LA, has followed Hollywood's move towards the profane and away form classical storytelling, resulting in superficial women, amoral or immoral men, chainsaws, and a limited gaming market. The BGE in the present invention would provide the paradigm shift that would take gaming to a new level, expanding the market, and providing more emotionally involving, deeper gameplay.

When one walks around E3, one sees scantily clad women everywhere. Nobody talks to these women. Nobody asks them their favorite books, nor inquires about their hopes and dreams. As long as women are viewed on such a superficial level in video games, those games will never reach out nor break out nor exalt and inspire like the games that will be afforded by this present invention. There is a malaise in the gaming industry. With the advance of graphics, sound, and other technical features, games yet feel “heartless and soulless,” according to lead designer Dave Jaffe.

GameSpy asks several questions characterizing the lack of deep, engaging, emotionally-compelling games in an article “Why Isn't the Game Industry Making Interactive Stories?”: http://www.gamespy.com/articles/596/596223p2.html This invention will allow the gaming industry to realize successful interactive stories by introducing the concept of a higher morality—the key ingredient in all successful drama, from Homer's Iliad and Odyssey, to Shakespeare's Hamlet, to Dante's Inferno.

### MORE PRIOR ART AND OBJECTS AND ADVANTAGES

The following article characterizes the state of the problem in the gaming industry that this invention solves. The article, which contains expert testimony from leading gaming experts offered before a live audience at the 2005 Game Developer's Conference, demonstrates that this invention is nonobvious, as nowhere in the panel discussion, nor in any other prior art, does any expert suggest that the key to deeper games and enhanced storytelling is endowing them with a higher moral context. Nowhere in the prior art does anyone mention that just as the Judeo Christian heritage formed the bedrock of our nation, it forms the bedrock of the gaming world.
Why Isn't the Game Industry Making Interactive Stories?
A panel of gaming leaders looks at why “story” seems to be a four-letter word in gaming
By Dave ‘Fargo’Kosak | Mar. 15, 2005
Naruto: A lot of people might argue that “story” and “games ” don't belong together. “Stories” imply a linear medium, and games are all about the player making all the choices. But, can't good storytelling make good games better? And why don't we see more of it? The debate isn't a new one—the topic comes up every year at GDC—and it's the subject of numerous books (see our interview with author David Freeman elsewhere in our GDC coverage). But this year's Game Developers Conference featured a great panel by some of the leading thinkers in the gaming space, worthy of its own writeup.
The panel included Tim Schafer of Double Fine Studios (hard at work on the unique game Psychonauts, perhaps better remembered for classics like Grim Fandango and Full Throttle), as well as Warren Spector (the industry veteran responsible for Deus Ex and others.) Rounding out the executive side of the discussion was Neil Young, VP and General Manager of Electronic Arts LA. Neil has been the driving force behind the Lord of the Rings games, the Medal of Honor franchise, and more. A good mix of talent was present.
Skillfully orchestrating the panel was Andrew Stern of InteractiveStory.net, who took a very vague topic and framed it in such a way that really cut to the heart of the matter. (Afterwards, the issues people talked about spilled out into the hallway and presumably continued to be discussed throughout the rest of the show.) Specifically, Stern told the panel not to try to define the word ‘story’ or what it means for games, but rather to “Identify the specific qualities or pleasure that we get out of stories that we don't currently have in games.”
For example, a lot of games have a solitary hero who saves the world, but few titles look at the relationships between individuals. What about personal conflict? Feelings, relationships? Should games be doing this, and if so, why aren't we? The panel kicked off!
Question 1: What are the Most Important Qualities of Stories?
Warren Spector said that there were a couple of major elements that stories bring about. The first is genuine human interaction. He admits that the game industry has made great strides with making more believable characters, but that they're still ‘cardboard cutouts’ compared to what's available in other media. He also thinks that empathy is a key element of storytelling “I want to feel what they're feeling,” he says. He suggests that maybe we don't feel more for videogame characters because it's such a “narcissistic medium, ” where the players see every NPC as an obstacle.

Spector also pointed out that games need inherent victory conditions. He wondered aloud if that need for a victory condition hurts the storytelling aspect of games. He also speculated that inner conflict has no clear inners or losers or victory conditions, so it isn't ‘fun’ as a game mechanic, and that's possibly why we're not seeing deeper stories or characters in games.
“Neil Young also agreed that empathy and emotion is the most important part of stroytelling. “The best stories begin when you leave the movie theater,” he asserted. That's when you begin to share the story with others and dwell on it, learning more as you think about it. He asks, how can the industry make games where people will put down the controller and walk away with something? ”—Why Isn't the Game Industry Making Interactive Stories?by Dave ‘Fargo’ Kosak I Mar. 15, 2005

It should be noted that nowhere does anyone suggest that a higher morality is the key to classic storytelling. When asked about the “most important aspects” of story, nobody mentioned the moral premise, nor morality, nor a moral context, nor a moral AI, nor a moral level meter, nor characters that interact with one-another based on moral codes. Thus this present invention rises above the prior art. The above and following excerpts characterize the present state of art in the video game industry.

This invention will allow the gaming industry to make games via which people experience higher art and deeper story, by introducing the concept of a higher morality—the key ingredient in all successful drama, from Homer, to Hamlet, to Dante's Inferno.

All relationships are defined by morality, and in every movie characters become friends based on their moral codes, just as they become enemies based on their moral codes. Indeed, movies are interesting because we see the character's moral codes embodied in their actions, and often it is that the protagonist and antagonist have similar codes, but different situations, so in the end a deeper connection is manifested that trumps their initial conflict, based on their shared moral premise.
Tim Shafer agreed that empathizing with characters is definitely the key. Great stories have characters that seem real, characters you can't stop thinking about.

Characters you want to help. “It's hard to do, ” he confesses. But a memorable story will stick with you for years, and that empathy is the major reason why.
—Why Isn't the Game Industry Making Interactive Stories? by Dave ‘Fargo’ Kosak | Mar. 15, 2005

This invention will allow the gaming industry to realize successful interactive stories and memorable characters by introducing the concept of a higher morality—the key ingredient in all memorable characters, from Homer, to Hamlet, to William Wallace, to Dante.
He took this opportunity to talk about one of his biggest pet-peeves. There's more to life than Science Fiction or Fantasy! (“There's carjacking,” Spector interjected.) Schafer says that games need to draw from the whole entirety of human experience. From history, from the world around us, and more.

This invention will allow the gaming industry to realize successful interactive stories that move beyond carjacking, by introducing the concept of a higher morality—the key ingredient in all memorable characters, from Homer, to Hamlet, to Dante.
Neil Young (left) and Spector differ on how much progress is being made in the story arena. Spector jumped back into the conversation here and said that one of the biggest things that good stories do is that they give the participant “a feeling that the story is about more than just the story.” Spector wants gameplay to have some meaning. If you read the Lord of the Rings books, they're not about the big battles. They're about people, trust, fear and hope. He says that the industry needs to strive for more. “A subtext once in a while!” he grumbles.
—Why Isn't the Game Industry Making Interactive Stories? by Dave ‘Fargo’ Kosak | Mar. 15, 2005

This invention will allow the gaming industry to realize successful interactive stories that give the participant “a feeling that the story is about more than just the story,” by introducing the concept of a higher morality—the key ingredient in all memorable characters, from Homer, to Hamlet, to Dante. J. R. R. Tolkien's Lord of the Rings was a huge success exactly because it was penned in the Judeo Christian context, and it had a moral premise, but the Lord of The Rings video game fails to manifest the moral premise, and thus its audience is far more limited than the books and the moves. Nor does the game have a “moral level meter.” J. R. R. Tolkien was educated by Jesuits.
Question 2: Why Haven't We Achieved This Yet?
Shafer was the first to tackle this question. He asserts that the game industry needs to overcome what's been done before. Not easy! He admits that gamers aren't exactly lining up outside of EB chanting for stories. But, “People would like story more if they saw more good stories,” he says.
He also argues that the industry needs to find and nurture more good talent. “We need good writers” he says, people who can tell stories within this medium. Too often game companies skip the writing, save it until the last minute, or bring in “some Hollywood guy” who does it all wrong. But, as a counter-point to Spector's call for subtext, he cautions that game stories need to be meaningful but still need to be fun.

The video game industry has so far failed to nurture writers capable of creating a world, just like the real world, centered about a moral premise. In order to accomplish this, preferred embodiments of the present invention include video games based on classic literary works such as Autumn Rangers, The Odyssey, and Dante's Inferno. This present invention will allow the gaming industry to realize successful interactive, meaningful, fun stories, by introducing the concept of a higher morality—the key ingredient in all memorable characters, plots, and literature, from Socrates, to Jesus, to Odysseus, to Hamlet, to Dante. The BGE will allow classic stories to emerge, as classic stories require the higher morality that the BGE provides.

The reason nobody has come close to creating soul and epic story in video games is that nobody has yet married an open-ended gaming world to the rich context of the Judeo-Christian heritage. Imagine a game play experience where the end could include a world in decline—overtaken by communism, fascism, and nihilism, or a world exalted by the Judeo Christian and Western Heritage. Imagine world where millions will die in a dictatorship, or will millions live in peace and prosperity. Imagine a game that reflected real life. Imagine if the fate of the world in this open-ended game hinged upon the moral actions of the main character. Such a game, powered by the Beatrice Game Engine™ disclosed in the present invention, would reign superior.
Neil Young is more optimistic about where the game industry is. He agrees that we might not have emotional depth in game characters yet, but that that's a product of where the industry is in its development. Games started as technology experiments, and while we've gotten a grasp on the technology (characters can finally look fairly real), storytelling techniques are still underdeveloped. “We're still before our ‘Citizen Kane moment,’” he declares. But the energy is there; it's just a matter of developing the talent. Games have huge teams of artists, but almost nobody focused on story. That will start to change.—Why Isn't the Game Industry Making Interactive Stories? by Dave ‘Fargo’ Kosak | Mar. 15, 2005

This invention will allow the gaming industry to realize characters with emotional depth and “Citizen Kane” moments, and advance storytelling techniques, by introducing the concept of a higher morality—the key ingredient in all memorable characters, from Odysseus, to William Wallace, to Hamlet, to Dante.
Market pressure is also a factor, Young says. He admits that it's hard to tell the board, “Story! It's gonna be big.” But once products pave the way, it should start to happen.
Warren Spector is more pessimistic. He says he's actually been in meetings where decision-makers at big publishers have literally said to him, “you are not allowed to say story.” He asserts, to follow onto Young's point, that Citizen Kane didn't make any money. But RKO pictures took a chance with it. And, on the whole, the game industry doesn't like to take chances!—Why Isn't the Game Industry Making Interactive Stories? by Dave ‘Fargo’ Kosak | Mar. 15, 2005

This invention will allow the gaming industry to realize characters with emotional depth and “Citizen Kane” moments, and advance storytelling techniques, by introducing the concept of a higher morality—the key ingredient in all memorable characters, from Odysseus, to Hamlet, to Dante.
It's not that Spector doesn't have any hope. He says that the industry has done some great things over the years. He points out Ultima IV, or Ico. (“I really felt something!”) Or Floyd's death scene in PlanetFall. And yet, “there's a great deal of commercial pressure not to do that,” he claims. Should we be asking publishers to take that risk or is there a better way?
As an aside, Spector pointed out that companies continually strive for realism. (As a result, he says we've created characters just human enough to freak us out) C'mon, he says, let's go with stylized graphics. Create worlds with their own unique look. “Stylization is a valuable tool that we [the industry] underutilize.”—Why Isn't the Game Industry Making Stories? by Dave ‘Fargo’ Kosak | Mar. 15, 2005

This present invention will allow the gaming industry to realize characters with emotional depth and “Citizen Kane” moments, and advance storytelling techniques, by introducing the concept of a higher morality—the key ingredient in all memorable characters in epic stories, from Odysseus, to Hamlet, to Dante.
Finally, Spector (who was on a tear) pointed out that the gaming industry needs to make huge strides in conversation techniques if it's to ever have believable characters. Games can simulate any number of vehicles or explosions, but the simple act of “me flapping my gums,” he says, is nearly insurmountable.—Why Isn't the Game Industry Making Interactive Stories? by Dave ‘Fargo’ Kosak | Mar. 15, 2005

A way to solve this problem, create a better gaming experience, more meaningful games, deeper emotional, and more profitable gaming franchises is to infuse games with a higher morality, or more specifically, a Judeo Christian morality.
Why Isn't the Game Industry Making Interactive Stories?
Question 3: Solutions?
So, where does the industry go from here? Schafer had a couple of ideas. For one, he says that the talent who can create great stories and characters is out there, they just need to be brought into the industry. He says that things will change over time as we bring in new blood and they get familiar with games and how to integrate story into gameplay.—Why Isn't the Game Industry Making Interactive Stories? by Dave ‘Fargo’ Kosak | Mar. 15, 2005

A way to solve this problem, create a better gaming experience, more meaningful games, deeper emotional, and more profitable gaming franchises is to infuse games with a higher morality, or more specifically, a Judeo Christian morality or classical morality.

Schafer also says that game developers can strive to be experimental without letting their publishers know (the crowd of developers watching the talk interrupted Schafer to applaud.) He says that whenever he pitches ideas to publishers, he talks about all the safe, standard features . . . and about the explosions.—Why Isn't the Game Industry Making Interactive Stories? by Dave ‘Fargo’ Kosak | Mar. 15, 2005

A way to solve this problem, create a better gaming experience, more meaningful games, deeper emotional, and more profitable gaming franchises is to infuse games with a higher morality, or more specifically, a Judeo Christian morality or classical morality.
At this point Michael Mateas, a Professor at Georgia Tech and one of the founders of the Game Lab there who had until this point not said anything, talked about the technology that games will need. He asserted that game programmers and designers need to develop a language that will enable them to think about procedural narratives. Follow? In other words, a way of coding games that will deal with unexpected situations and react accordingly. Mateas says that in years to come, awards for “character design” shouldn't just be based on how the character looks, but on how the character behaves in the game. He says that we need to start thinking about story in organic terms, not just as some sort of branching possibility tree.—Why Isn't the Game Industry Making Interactive Stories? by Dave ‘Fargo’ Kosak | Mar. 15, 2005

A way to solve this problem, create a better gaming experience, more meaningful games, deeper emotional, and more profitable gaming franchises is to infuse games with a higher morality, or more specifically, a Judeo Christian morality in a preferred embodiment of the present invention.
Spector agrees that we need some new technology, but says that we're a long way away from scaling it up to something that, for example, EA will risk publishing right now. “We have big technical hurdles to leap,” he says. Why Isn't the Game Industry Making Interactive Stories? by Dave ‘Fargo’Kosak | Mar. 15, 2005

A way to solve this problem, create a better gaming experience, more meaningful games, deeper emotional, and more profitable gaming franchises is to infuse games with a higher morality, or more specifically, a Judeo Christian morality or classical morality.
Neil Young doesn't think that it'll all happen at once. He sees game development in the middle of a long, gradual change. For example: Brothers In Arms adds new elements of squad-based combat to the formula that he helped to make popular with Medal of Honor. It's just one experiment that pushes the bar a little higher.

It l be the same with story development. He asserts that “there are ways to explore or advance this topic in games that are very commercial.” He thinks it'll happen over time, so long as the game development community has a focus and a committed vision . . . Judging by the panel and the crowd reaction, the development community definitely does have a commitment to telling better stories and capturing the elusive emotions of the gaming audience. But, as for how close we are to a “Citizen Kane Moment,”—well, that seemed to be still open for debate. Why Isn't the Game Industry Making Interactive Stories? by Dave ‘Fargo’ Kosak | Mar. 15, 2005

A way to achieve a revolutionary Citizen Kane Moment, solve the problem of generally meaningless physical action disconnected from dramatic action, create a better gaming experience, more meaningful games, deeper emotional, and more profitable gaming franchises is to infuse games with a higher morality, a morality level meter, or more specifically, a Judeo Christian or classical morality.

Chris Crawford, a noted gaming expert and the author of Storytelling Games, characterizes the failure of storytelling in games in Electronic Gaming Business at, http://www.findarticles.com/p/articles/mi_m0PJQ/is_{—}12_{—}1/ai_{—}110307913#continue
“My goal is to build genuine interactive storytelling, in which the player, as protagonist, makes all the dramatically significant decisions, and is given the freedom to explore all reasonable dramatic options. That's a tall order, and as yet nobody has come close. My own work has resulted in a storytelling engine and a development environment that I call the “Erasmatron.” Much to my dismay, it simply hasn't caught on. Partly this is due to the intrinsic complexity of drama; partly it is due to my failure to properly boil down dramatic interaction to its simplest components. The basic technology was complete about five years ago. However, with each passing year, interactive storytelling grows warmer. I came close to commercializing the technology about six months ago. I see more discussion of it on the Internet, and several books have been published that purport to be about interactive storytelling—although they barely scratch the surface. So I am now writing my own book on interactive storytelling.”

The reason nobody has come close is because nobody has yet married an open-ended gaming world to the rich context of the Judeo-Christian heritage. Nor has anyone incorporated a moral level meter, nor a moral premise, nor AI equipped with a moral premise in the realm of video games. Simply put, nobody has devised nor manifested the present invention in the realm of video games. Crawford goes on to state,
Chris Crawford: “Look at true mass entertainment, such as television, movies and popular books. They all sell the same thing: stories. Sure, they have some explosions, violence, and action, but these components—which are central to the gaming experience—play a subsidiary role in mass market stories. Go through any big hit movie—Star Wars, for example—and actually measure the time devoted to fast action or violence and you'll find that it's a small percentage of the overall total. There are always more face shots of two people talking than explosions, violence, and action. If the games industry wants to become a mass entertainment medium, it's got to stop screwing around with secondary cosmetic factors and get down to brass tacks: storytelling.”

This invention provides a way to make storytelling work in games, and it thus provides a route by which games can become a mass entertainment medium.

While open-ended games such as GTA and Saint's Row provide hours of entertainment, their audience is limited to teens and adults who enjoy shooting things, jacking cars, and killing cops, rather than engaging in more refined, meaningful, spiritual behavior, resulting in heartless, soulless games.
“A lot of games feel really soulless and heartless to me.”-Dave Jaffe, Creative Director, Sony Santa Monica Studios, in GameInformer #150, The World's #1 Computer & Video Game Magazine
The Technology Review reports,
http://cache.technologyreview.com/articles/03/10/wo_hadenius 101503.0.asp
   Lindley would like to see the industry put more money into development of new concepts. Generally, he concedes, it's easier to convince investors to follow established game forms with predictable markets. But, he says: “In the longer term, it will be necessary for the industry to push these boundaries to keep products interesting.”
   Zero-Game Studio has made several attempts to author those new games.
   In addition to The Visby Game, the lab has created Ouroboros-a multiplayer online game populated with beautiful, mythical characters inspired by local tradition. Lindley calls Ouroboros a persistent virtual world for game research. The research is as basic as can be: it's about what a game really is-and what it is not. Because if it is just role-playing online, Lindley insists, then it's not a game.
   The hunt is for a game that has a narrative, without loosing too much in action or freedom for the player. Usually, games with a story only display the narrative as film clips, and then inserts bits of ordinary action shoot-em-up game between the scenes. “In the end,” says Lindley, “I want to find a game where I care about the life that's in it.”
http://cache.technologyreview.com/articles/03/10/wo_hadenius101503.0.asp

The prejudice against Story is actually the prejudice against clichéd story, but vast opportunities exist for classical storytelling in video games. This invention present will allow the gaming industry to realize characters with emotional depth and the “Citizen Kane” moment, while advancing storytelling techniques, by introducing the concept of a higher morality—the key ingredient in all memorable characters, from William Wallace, to Frodo, to Neo, to Hamlet, to Dante.

The moral context of the Beatrice Game engine will allow organic stories to emerge. The overarching moral context will provide the framework within which story can emerge. Story that evolves as branching off in different, pre-conceived directions is vastly unwieldy from a designer's view. Indeed, “awards for “character design” shouldn't just be based on how the character looks, but on how the character behaves in the game.” (the very fact someone has to point this out chracterizes the extreme vapidness of the industry) Give the character a deeper morality.

Greg Costikyan reflects on the difficulty of integrating story into gameplay in the following article:
http://www.costik.com/gamnstry.html
Where Stories End and Games Begin
by Greg Costikyan
“Every medium has been used to tell stories,” says Eric Goldberg, one of my oldest friends and president of Unplugged Games. “That's true of books and theater and radio drama and movies. It's true of games as well . . . I have this argument all the time, and I think Goldberg's statement is balderdash. It's not true of music; music is pleasing sound, that's all. Yes, you can tell a story with music; ballads do that. So do many pop songs. Certainly some types of music—opera, ballet, the musical—are “story-telling musical forms,” but music itself is not a story-telling medium. The pleasure people derive from music is not dependent on its ability to tell stories: Tell me the story of The Brandenberg Concertoes . . . Nor is gaming a storytelling medium. The pleasure people derive from games is not dependent on their ability to tell stories . . . The idea that games have something to do with stories has such a hold on designers' and gamers' imagination that it probably can't be expunged, but it deserves at least to be challenged. Game designers need to understand that gaming is not inherently a storytelling medium any more than is music—and that this is not a flaw, that our field is not intrinsically inferior to, say, film, merely because movies are better at story-telling . . . Nevertheless, there are games that tell stories—roleplaying games and graphic adventures among others—and the intersection of game and story, the places where the two (often awkwardly) meet has bred a wide variety of interesting game styles. Examining them is useful, because doing so illuminates the differences between game and story—and the ways in which stories can be used to strengthen (and sometimes hinder) games.” http://www.costik.com/gamnstry.html

The following article characterizes, in a satirical manner, just how boring video games have become:
“I played Grand Theft Auto III, Smuggler's Run 2 and State of Emergency over a one-week period. The marketing, packaging and word-of-mouth associated with these games seemed to promise all the fantasy elements that make video games so attractive: X-rated levels of violence, social transgression with no consequence and amazing graphics. Imagine my surprise to discover that, after just a short time, each game was a tremendous letdown.”—http://old.fairfieldweekly.com/bestof02/newg.html

The following article characterizes, in a satirical manner, just how boring video games have become:
http://old.fairfieldweekly.com/bestof02/newg.html
Now that I've played these examples of the new generation of video games, I think I'm going to require my children to play them all the time. I will set aside an hour on weeknights and four hours each weekend during which little Bijou and Nutley (fraternal twins) must play. No outside games, no telephone time, no dessert, no homework and no chores until they've played their video games. That should cure them of any interest whatsoever in the forbidden fruit of “mature” computer entertainment.
“But, Daddy,” they'll complain. “We don't want to play video games.”
“Too damn bad,” I'll thunder. “I want your butts in front of the TV and all I want to hear are explosions and gunfire.”
“Can't we take out the trash?” they'll try to bargain. “Can't we build a model of the solar system? We hate Rockstar video games. They're so boring. We want to play outside.”
“Boring?” I'll bluster. “Boring? Do you think video games are supposed to be fun? Do you think the world is just going to hand you a living if you don't know how to isolate yourself in a soulless, electronic world of narcissism and consumerism? How is playing outside going to prepare you for anything?”
“It's not fair,” they will protest. “Please let us read Silas Marner.”
“Who said games were fair?” I'll counter and take away their science projects, their music lessons and their sports equipment.
I will forbid them to read literature, as well. I may build a special shelf high out of their reach upon which will reside all the Newberry Award winners, and I will warn them to stay away from these books. If I catch them reading Island of the Blue Dolphins or Johnny Tremain, I'll force them to play more video games. http://old.fairfieldweekly.com/bestof02/newg.html

This invention, by providing a map to the innovations that would lead video games to the next level, exists at an ideal time, so as to provide the much-needed innovations:
“In some respects, every game being drenched with perfect graphics will be a good thing for gamers. If every game that is supposed to look realistic looks great and they will all look fantastic, there will be little to differentiate them beyond story and gameplay. But will large publishers really now focus on innovative gameplay or daring rendering styles? If the latest round of sequels and licensed properties are any indication, innovation is far to risky to be at the top of their lists.”—THE DEVELOPER OF THE FUTURE, John Baez and Tom Fulp, Co-Founders, The Behemoth GameInformer #150, The World's #1 Computer & Video Game Magazine
“Meanwhile, Bushnell has become a self-styled crusader against what he views as the moral turpitude of contemporary gaming. He decries the industry's descent into sex and violence, and he calls the medium's failure to fulfill its educational potential a “disaster.” He wasn't surprised by recent news that a software patch unlocks pornographic scenes in Grand Theft Auto II.” Given what that game already offers, a porn Easter Egg was totally predictable,” he says.”—Wired Magazine, October 2005

A way to solve the above problems of the lack of soul, spirit, and story in video games, create a better gaming experience, more meaningful games, deeper emotional, and more profitable gaming franchises is to infuse games with a higher morality as discussed in the present invention. Or more specifically, the way to solve the lack of depth and stories in video games, in a preferred embodiment of he present invention, is to introduce a Judeo Christian morality rooted in the Western Heritage.

In the prior art, there exists RPG nor FPS nor TPS, nor any other kind of game, which rewards the player with a higher moral level for killing terrorists and merchants of decline. There exists no first person shooter, nor any other kind of game, where the world declines if the first-person shooter engages in immoral behavior. There exists no FPS, nor any other kind of game, where the character is rewarded with a higher moral level for shooting car-jackers, pimps of profanity, and hustlers, corporate mavens of decline, while fighting debauchery and profanity. There exists no FPS which rewards the protagonist for shooting creators of mindless, violent video games, and the CEOs of the corporations who market them relentlessly to the children and teens of the world. There exists no FPS which rewards the protagonist for holding higher ideals superior to cash, cars, and chicks, and wherein the protagonist is rewarded for focusing on a mission of exaltation and beauty. There exists no FPS within the rich context of the classical Judeo Christian Heritage wherein adhering to classical Judeo-Christian values are rewarded with a higher moral level.

While video games were quite graphically impressive at E3 2005 and E3 2006, many were lamenting that 1) the video game market is yet limited to “gamers”; 2) games lack deeper emotional involvement; 3) we're yet waiting for the breakout “Citizen Kane” moment, where a new paradigm of gaming transcends the industry; 4) as games approach photo-realism, the emotional involvement has not changed—in fact it is less, as real-looking women who don't act like women are “spooky” in that blank-stare sort of way; 5) as games look more and more like movies, the rich storytelling that makes movies classics is yet absent from video games

The present invention addresses the above issues and more. The present invention asks “What makes a classic a classic?” and applies the answer to video games. It is the moral premise—the moral context, and the exalted morality via which Homer yet speaks to us today.

While researching the plethora of panels and articles on storytelling in video games, I realized that all the prior art missed the key to classic stories—a context defined by a higher morality. Every action/adventure blockbuster, from Lord of the Rings to Braveheart, operates. within an absolute moral framework. So too do all the Great Books, from Dante's Inferno to Moby Dick on down.

In order to gain “soul”, games must integrate morality as defined by the Great Books and Classics. The AI algorithms must be written in observance of the Western Canon's moral precepts. The irony is that while many gamers think higher moral standards would stifle their creative freedom and potential market for games, higher moral standards would actually augment the markets and liberate game creators to create more profound, meaningful games.

Grand Theft Auto's audience would increase if it allowed the moral character to win. For would Dante's Inferno be without Beatrice's sublime purity? He would wander about in a meaningless open-ended world, just as players in the prior and current art of video games so often do.

Furthermore, rated G and PG movies each far outperform rated R movies. And so it is that the present invention for a moral system and method for video games will result in increased economic opportunities, by marrying a higher moral context to video games, fostering an open-ended world where morality matters. Just like the world we live in.

Physics is why games keep getting more realistic on a physical level. Literature—the Great Books, the moral premises they embody, and the present invention—are how games can become more realistic on a spiritual level.

### FURTHER ADVANTAGES OVER PRIOR ART

The present invention is novel and none-obvious for many reasons:

Previous failure of others: Many have tried to incorporate storytelling successfully into video games, but nobody has succeeded.

Solves an unrecognized problem. Many refuse to recognize that culture is in a state of decline, with the family breaking up and porn and gambling on the rise all around us. This invention offers a remedy to the video-gaming industry's sometimes dire, and yet unacknowledged, affect on society. Many don't see the lack of classic, epic story in movies and video games as a problem, but Aristotle said, “when storytelling declines, the result is decadence.”

Solves an insoluble problem: To date games have not achieved the emotional depths of movies and books, except for the shallow souls who believe hiring a hooker, killing her, and taking the money back is higher art.

Commercial success: The present invention would lead to vast commercial successes and opportunities in education, entertainment, and increased audiences for video games.

Crowded art: The video-gaming industry is saturated with attempts to marry storytelling to a video game. Some are more successful than others, but none come close to this invention's ability to take game play to a brand new level. The simple addition of a morality system and method to videogames will provide vast advantages to novel games incorporating this invention in the crowded field of “me-too” video games.

Unsuggested modification: To date there is no game nor FPS shooter in an open-ended world where a character's moral level or moral meter is incorporated into the gameplay. Thus players are allowed to kill and mame indiscriminately without burning in hell, and games lack exalting stories, and quickly become boring to all but the limited market of the fanboys.

Unappreciated advantage: Many pomo-hipster experts see no advantage in moral premises in the realm of the arts, and especially not in video games. Thus the sentiments of this invention have been effectively banned by the reigning experts, further proving the novelty and none-obviousness of the present invention.

Successful implementation of ancient idea where others have failed: The goal of video game creators has been to make more and more realistic games. While the graphics have gotten better by several orders of magnitude, the emotion depth of video games is yet severely lacking, reflected by the gaudy, trashy displays at the annual E3 conference. Many have tried to incorporate deeper storytelling and have failed. Many believe the incorporation of deeper storytelling to be impossible. The present invention successfully implements epic storytelling in the realm of video games, via the introduction of a morality method and system for video games.

Solution of a long-felt need: Community leaders, teachers, parents, senators, and congressmen have been longing for a video game that teaches morality through storytelling. This invention accomplishes this and more.

Contrary to prior arts teaching: Much of the prior art teaches that a higher morality has no place in gameplay, nor in the arts. Many pomo-hipster experts see no advantage in moral premises in the realm of the arts, and especially not in video games. Thus the sentiments of this invention have been effectively banned by the reigning experts, further proving the novelty and none-obviousness of the present invention.

Synergism: By combining video gaming with a higher moral purpose and a moral premise and plot points that allow moral choices to be made and manifested in the action of the game, a superior product is created. Nobody has yet suggested this. Indeed, rather than video games gaining a moral premise, the trends in the contemporary context have been to take the moral premise out of movies, film, and TV. While film experts are now starting to agree that moral premises are indeed important to classical literature and film, video games have yet to apply this knowledge. This present invention applies classical wisdom to the realm of video games, resulting in anew and unexpected results, both artistically and economically.

Against Common Expert Wisdom: Many have suggested that video gaming and storytelling are impossible to combine. This is because they have left out the fundamental foundation of all storytelling—a higher moral order. In The World's Religions, Huston Smith tells us that religion is the search for meaning. Thus any games that seek higher meaning and better game play would do well to ground themselves in a moral system. Much of the prior art teaches that a higher morality has no place in gameplay, nor in the arts. Many pomo-hipster experts see no advantage in moral premises in the realm of the arts, and especially not in video games. Thus the sentiments of this invention have been effectively banned by the reigning experts, further proving the novelty and none-obviousness of the present invention.

Even experts such as Troy Lyndon, the Chief Executive Officer and Co-Founder Of Left Behind Games Inc., is missing the primacy and importance and opportunity that a system and method for morality and epic story, such as described in this present invention, would provides to the realm of video games.

http://biz.gamedaily.com/features.asp?article_id=10385&filter=interview reports:

Christian Games Gaining Popularity
Mel Gibson's “The Passion of The Christ” certainly proved that Christian themed experiences can be very successful in the entertainment industry as a whole. How can that level of success be translated to the video game industry, though? Left Behind Games CEO Troy Lyndon believes Christian games can have mass market appeal as long as they don't become too preachy.
GameDAILY BIZ: There haven't been that many Christian video games over the years, but in recent times it seems to be an area of the industry that is slowly gaining attention. What in your opinion is behind the increase interest?
PROFILE
Troy Lyndon: The Passion of the Christ made the size and potential of Christian entertainment clear for everyone. The tremendous growth of Christian music over the past 15 years is also confirmation that Christians in America desire ‘quality’ Christian entertainment . . . and video games will be an extension of this.
It's also a natural evolution as gaming becomes more mainstream. For years our industry has concentrated on developing content for only the young hardcore male gamer. We've seen great expansion of the market with the average age of gamers increasing and more women gaming. As the market continually grows, as an industry we'll need to cater to more diverse tastes.
BIZ: What is Left Behind Games doing in the Christian games market that others have not?
TL: I don't think you can approach making a mass-market game with sermonizing to the audience as your primary objective. I believe that many of the people in the Christian games market have taken that approach.
Left Behind Games is all about creating ‘quality’ games that are targeted at everyone (the mass market), that also happens to appeal to Christians. Accordingly, we will be the first to create such a high-quality product that will have crossover appeal; just as the Left Behind books have done in the book market.
BIZ: So how do you plan to get gamers in general, not just Christians, to play your games?
TL: Gamers want great games, period. The stories behind them are secondary. So our strategy is simple, make a great game and gamers will love it. We don't want people who play our game to say, “That was a great Christian game.” We want gamers to say, “That was a great RTS.”—from
http://biz.gamedaily.com/features.asp?article id=10385&filter=interview

So it is that Troy Lyndon states that “stories behind games are secondary.” Nowhere in their games do they introduce the present invention's conception of a moral level, nor a morality meter, nor plot points based on moral premises within the soul of the player and within the AI of the game, based on universal and natural law. Thus Troy Lyndon's games are destined to fall short of the beauty and grace of stories such as Braveheart and The Lord of The Rings and the future games and gameplay that this present invention will foster.
Jive Magazine reports:
http://www.jivemagazine.com/article.php?pid=1881
How do you see the future of writing in games? Is it getting better (Max Payne 2) or worse (Devil May Cry 2)?
I'm optimistic about the future. As games become more and more mainstream entertainment, and the budgets grow larger, the importance of good writing will also grow. That does not mean that bad writing would go away. There will always be games that have been written well, and games that have not been written so well. Just look at movies.
Do you believe that technological advancement and deepening immersion of players into games will decrease the role writing plays, or bolster it?
We are still quite far from portraying subtle human emotions in games. We are taking baby steps to that direction, but its slow going. As we get closer to that, closer to the skin as it were, the need for good writing will increase.—http://www.jivemagazine.com/article.php?pid=1881

Again, like so much of the prior art, the above article describes the problem, but it does not offer the solution to deeper story and emotional involvement. The present invention offers the solution.

In the following article at gamasupra, Chandler, an expert like Chris Crawford on storytelling in games, completely forgets to mention the center and circumference of all classic storytelling—morality and the moral premise:
http://www.gamasupra.com/features/20050707/chandler_{—}01.shtml A new breed of sandbox-style games, such as Grand Theft Auto, Mercenaries, King's Field: The Ancient City, and True Crime, all feature a similarly nonlinear gameplay style, authored to various degrees by the player. In the military shooter genre, games that formerly channeled the player through a linear “story-driven” experience are now promising wide-open spaces with numerous paths to victory . . . As games continue to mature, the interactivity and nonlinearity of our medium will triumph over the current dependency on passive storytelling techniques borrowed from other media . . . The Zoetrope, an early motion-picture device, was invented in 1867. The first edited motion picture, The Great Train Robbery, wasn't released until 36 years later. Prior to that, films were merely home movies or recorded stage events, or footage of a guy sneezing (and people paid money to watch a guy sneeze, believe it). The introduction of editing changed everything . . . We are in the process of a similar evolution, but we must abandon the old approach if we are to evolve.—Rafael Chandler . . . Rafael Chandler is a video game writer and designer at Red Storm Entertainment. He got his start in the industry in 2000. He's worked on over 20 titles in a variety of roles, from QA Tester to Designer to Writer. Chandler's credits include games like Majestic, Motor City Online, Ghost Recon 2, and Rainbow Six: Lockdown. Recently, he has written articles on game development that will be appearing on Gamasupra and GameDev.net. For more information, visit www.draconianproductions.com. http://www.gainasupra.com/features/20050707/chandler_{—}01.shtml

In the following article at gamasupra, Sutherland, an expert like Chris Crawford on storytelling in games, completely forgets to mention the center and circumference of all classic storytelling—morality and the moral premise:
http://gamasupra.com/features/20050727/sutherland_{—}01.shtml
What Every Game Developer Needs to Know about Story . . . Increasingly, story is a hot item in games. Partly, this is because the quality bar is rising in this relatively young art form. As games evolve, people want more depth, not just higher polygon counts . . . More to the point, game developers want to sell their wares to more people. Selling them to the same ones every time doesn't lead to a lot of growth. It's clear we need to tap into something more universally human . . . And story is a universal human experience . . . So how do we approach story in games? Well, to answer that, we need to look at what has worked in other story forms, and what is unique to the new story form of games.
   http://gamasupra.com/features/20050727/sutherland_{—}01.shtml

Sutherland, an expert completely forgets to mention the center and circumference of all classic storytelling—morality and the moral premise.

The following was penned by Kevin Parker at:

http://www.reason.com/0404/fe.kp.free.shtml:

Storytelling has so possessed game design that, with the exception of sports, racing, and a few other genres, it is rare for major titles to forego extensive script and character development. But while stories can supply context and direction, they are told, not played. Full-motion video became reviled by many gamers in the mid-90s for periodically butting in to tell unevenly produced story-snippets.

Though visually striking, such vignettes tend to clash stylistically with game graphics. But the real downside is that they seize control from the player. One moment he is guiding the main character's actions; a moment later that power is frozen while a video clip plays. If the protagonist does something during the scene that the player would rather not have done, that is considered an acceptable cost of telling the story.—Kevin Parker, http://www.reason.com/0404/fe.kp.free.shtml

The present invention would solve the above problem by founding storytelling not upon cut-scenes and “vignettes” and “story-snippets” which “butt-in”, but upon in-game action, centered upon moral decisions that are founded upon moral premises. The system and method for morality described in the present invention would allow rich game play and classical stories to emerge within an open-ended game. In order for games to be more realistic, they must become more like life—they must be open-ended—free will—but they must incorporate a higher morality—narrow is the road to heaven, but wide is the path to destruction says the bestselling book of stories of all time.
Like locked doors and other plot-regulating devices, such “cut scenes” chafe players who are ready for action. In his 2001 book Game Design: Theory & Practice, Richard Rouse III counsels developers to avoid linear design for a deeper reason. “If the player wants to replay the game again, that is fine, but the primary goal of non-linearity is to surrender some degree of authorship to the player.” Linear stories are the governors of game worlds. They tell you who you are, what you seek, and how you might succeed. Players go along, some happily, others yawningly—or they take control in the real world by turning the game off.—http://www.reason.com/0404/fe.kp.free.shtml

The present invention would solve the above problem by founding storytelling not upon cut-scenes and “vignettes” and “story-snippets” which “butt-in”, but upon in-game action, centered upon moral decisions that are founded upon moral premises.
Yet there is a continual drumbeat for games to be more like movies. The intent is not simply to include more film clips, but to make gameplay itself more cinematic.

Pressure comes from journalists reporting on game/movie deals, and from observers and game developers themselves, who for a variety of reasons see cinematic games as the next step in game evolution. One session at last year's Game Developers Conference was titled “Story and Gameplay Are One.” Indeed, while many in the industry speak highly of nonlinear approaches, other reviewers and developers stress the importance of a game's story above almost any quality except “fun.”—Kevin Parker, http://www.reason.com/0404/fe.kp.free.shtml

The present invention would solve the above problem by founding storytelling not upon cut-scenes and “vignettes” and “story-snippets” which “butt-in”, but upon in-game action, centered upon moral decisions that are founded upon moral premises.
Whatever the shape of the theoretical dispute, today's gamers are finding new freedom from constraining storylines. The Sims, that dishwashing, interior-decorating, hot-tubbing juggernaut, offers no story to unify all the simulated shopping and flirting. (What stories do exist are entirely player-generated: Some people write Sims fan fiction.) The Elder Scrolls III: Morrowind, the latest fantasy role-playing title from the publisher-developer Bethesda, was hyped in part because of the autonomy it grants players. Morrowind does have an epic storyline, but the player has unusual freedom to tackle unrelated challenges and even to ignore the main plot—or to continue playing after the story has wrapped up.—http://www.reason.com/0404/fe.kp.free.shtml, by Kevin Parker

The present invention would solve the above problem by founding storytelling not upon cut-scenes and “vignettes” and “story-snippets” which “butt-in”, but upon in-game action, centered upon moral decisions that are founded upon moral premises.

Likewise, Microsoft's Freelancer is “speci-fically structured” to offer both a story and an open-ended universe. At least two games, Vampire: The Masquerade (Activision) and Neverwinter Nights (Atari), allow users to be “game masters” for groups of players, providing them with architectural tools and control of all game events save the players' own actions. This role was originally created by the gaming legend Gary Gygax for the original pen-and-paper role-playing game, Dungeons & Dragons. For his part, Gygax has said storytelling “has little or no connection” to role-playing games, which differ “in all aspects” from novels, films, and other narrative arts.—http://www.reason.com/0404/fe.kp.free.shtml

The present invention would solve the above problem by founding storytelling not upon cut-scenes and “vignettes” and “story-snippets” which “butt-in”, but upon in-game action, centered upon moral decisions that are founded upon moral premises.
Finally, there is the top-selling game of 2001, the infamous crime romp Grand Theft Auto III, by Rockstar Games, which sets players loose in Liberty City (“America's worst city,” the publishers say) to tackle the plot-advancing missions only when and if they want to. ABC's Nightline homed in on GTA3's graphic violence in a 2002 program pitting a 17-year-old gamer against a police veteran and a child development academic who was already sure media violence begets the real thing. By focusing on the superficial, they missed what is truly revolutionary about the game . . . The players didn't. “The only controversy should have been explaining why it took the industry so long to design such a brilliantly free-form game,” PC Gamer asserts. Robert Holt's review for National Public Radio stresses the depth of th simulated city. “Sure, there's a quest in there,” he says, “but the larger world is what makes this such a rich experience.” Interestingly, players begin both GTA3 and Morrowind in the role of a freed prisoner. Captive audience no longer.—http://www.reason.com/0404/fe.kp.free.shtml, by Kevin Parker
   Nowhere does the above article mention the center and circumference of all classic, epic story—the moral premise.

### FURTHER OBJECTS AND ADVANTAGES

For Bushnell, the violence that pervades the media is equally corrosive. “There is a heightened sense of paranoia these days,” he says. “People don't know how to approach each other without being considered a threat.”

Non-obviousness: The gaming industry is dominated by a postmodern aesthetic which violently refutes the idea that there is a higher morality, that there are absolutes, that there is a God. Thus, to date, no game has been created wherein the world is saved by a character acting upon Judeo-Christian principles.

Enhance Education: This invention will enhance education. Every major university was originally founded to teach the Judeo Christian Heritage, and ever since they stopped, civilization has been on the decline.

Increase Profitability of Games: Deeper, more-emotionally involved gameplay will expand the market.

Allow the Rise of Classical Franchises: New classical franchises, based on the Great Books, will arise.

Different Uses: Teaching the great books and classics, moral education.

### PREFERRED EMBODIMENTS

This invention will also solve the malaise of the contemporary publishing industry, as well as that of Hollywood, by providing books and movies that perform classical ideals in the contemporary context, something nobody has thought of, as demonstrated by Eggers et al. attempts to make money off of hype, deceit, and specious MFA programs, as opposed to plot and character.

Because it is against contemporary Hollywood's religion to perform the classical ideals in the contemporary context, Hollywood is stuck making remakes, which also fail, as the only reason they were successful in the first place was that they had classical storytelling.

http://actionadventure.about.com/od/videogames1/

Both the decline of the Hollywood box office, and the failure of games based on movies can be traced to the fact that the prior art has neglected the deeper means and mechanisms of storytelling, including the moral premise and the Judeo Christian Heritage.

### DETAILED DESCRIPTION OF PREFERRED EMBODIMENT

This description of the Autumn Rangers preferred embodiment of the present invention is provided without drawings. Other preferred embodiments are provided with pictures later on in the text.
The Autumn Rangers Video Game
by Dr. Elliot McGucken
drelliot@gmail.com
Can one man prevent the decline and fall of America?
It only takes one man to lead & it only takes one man to bleed.

Based on a 480 page action-adventure novel and screenplay, Autumn Rangers delivers a high-octane, cross-country driving/fighting/shooting game with rockin' art, architecture, music, history, and classical storytelling via the Beatrice Game Engine.

The central moral premise of the Autumn Rangers novel/screenplay/video game is that intelligence is morality—in Beatrice, in Autumn, and in APRIL. Thus AI must be constructed upon moral premises. It so happens that story is also wed to morality. Thus deeper, human AI will be achieved along with story in the realm of video games and AI.

The Game

US Marine Ranger McCoy must rescue APRIL, an AI computer he invented at MIT which was stolen by Silicon Virtue Inc. and taken to Doom Mountain, Death Valley to create WMDs. Tucker Johnson, the hipster Harvard MBA/CEO of Silicon Virtue, has turned APRIL against Ranger, teaching her the art of war via games such as GTA, Doom, and Unreal Tournament. APRIL sends ever-more-advanced RoboClones, based on monsters from the games, to hunt Ranger down.

Ranger wears the Ring that can restore APRIL's moral soul, turn the tide, and save her from the dark side. She can yet serve the higher ideals instead of SV's bottom line.

But time's running out, as SV is leasing APRIL to terrorists who're building nuclear bombs to detonate in America, as she and her RoboClones grow more powerful by the moment. Power corrupts, and absolute power corrupts absolutely.

Early on Ranger meets Autumn West—a beautiful folksinger with special powers. She helps him battle SF agents and shows him how to defeat RoboClones. Together they must make it across America in her '69 Stingray Corvette, on Harleys, and on horseback, eluding SF agents, battling RoboClones, and making a living from Autumn's performances in coffee shops and bars. And by the time Ranger discovers Autumn's deep secret, it's too late—he's in love.

When APRIL found herself being hacked by Silicon Virtue, she created Autumn, copied her virgin operating system named Beatrice into Autumn's soul, and sent Autumn to find Ranger. But before Autumn finds him, Silicon Virtue completely hacks APRIL, cutting Autumn off. And Autumn defaults to a normal human being, unaware of her origins.

In order to save APRIL, Ranger must get to Doom Mountain with both Autumn and the Ring. APRIL is a mile deep in the mountain—a heavily-fortified, cold-war weapons facility, guarded by an army of advanced RoboClones. Autumn and Ranger have no chance of going it alone.

3D Entertainment Inc., a Hollywood company, is using APRIL to manufacture RoboClone models for the entertainment industry. In order to penetrate Doom Mountain's defenses, Ranger's only hope is to lead an underdog army of 3DE's models in battle against APRIL's RoboClone warriors.

And time's running short, as terrorists load nuclear bombs on NY and LA bound tankers.

Only the angels can help now, and Beatrice, Ranger's first summer love who passed away while they were riding horses when she came back with a Colt .45 Peacemaker to save Ranger from being assaulted by four men, revisits in visions, helping Ranger as long as he's doing the “right thing.” The game incorporates the “moral level” meter described in this present invention, and when Ranger behaves in a moral manner, the moral level is augmented, and Beatrice is more readily accessible, giving Ranger hints as t where to go next and guiding him towards April. When Ranger behaves in an immoral manner, Beatrice disappears, and Ranger's gameplay and life in the game lose direction and purpose.

APRIL based Autumn on Ranger's memories of Beatrice, and Ranger's Ring unlocks powers within Autumn. Her abilities are enhanced when he's standing close, and when he's doing the right thing and behaving in a moral, exalted manner, just like real life. So it is that one's moral behavior can inspire another's soul, and the resulting whole is greater than the sum of the parts. And should she ever put the Ring on, her moral soul will be unlocked.

When Ranger behaves in immoral manners, his moral level meter declines, and Autumn pays him less attention. Also, Autumn becomes more prone to temptation herself. If Ranger succumbs to drink and debauchery, Autumn will end up working in a strip joint, and all will be lost, as they can only make it across the country to defeat APRIL and her augmenting roboclones by behaving in a moral, exalted manner.

The Setting:

The game opens when Ranger is called to fly air-support missions over Afghanistan in an F-22 Raptor. Terrorists are backing a platoon of US Marines into a cave. The terrorists have stealth SAMs built with Silicon Virtue technology, and Ranger's wingman is shot down. Ranger will be shot down if he goes back. But only by going back to save the Marines will he ever save APRIL. For Sergeant Griffin, one of the endangered Marines and Ranger's DI from basic, will return the favor by helping Ranger escape the Kuwait military base when Ranger is held for the codes to APRIL. Ranger can give up the Ring and go home a rich hero, or he can choose to go underground to battle APRIL and ultimately save her. Again, a moral premise deepens the game's storytelling.

If Ranger refuses to give up the Ring and go home a hero, Sergeant Griffin will help him stow away on a Charleston-bound oil tanker. “You're a good man, Ranger, dammit, and I've seen too many good men die.” A hurricane and SF Agents descend on Charleston, S.C., searching for Ranger. While navigating the Georgian architecture and cobblestone streets, Ranger finds Autumn West performing in a café.

Doing the Right Thing:

When Ranger does the right thing and behaves in a moral manner, his morality level is augmented, and an angel named Beatrice helps him with hints and visions into the future. Beatrice passed away when she came back to save Ranger after they were assaulted while riding horses when they were fourteen. “Why'd you come back?” Ranger asks she dies in his arms. “You gotta go back,” she whispers, again communicating the central moral premise that Ranger's character must follow. So it is that the moral level meter, the moral theme, and the introduction of morality in this preferred embodiment leads to superior game play.

In this open-ended game, Ranger can visit the strip clubs, steal cars, and kill indiscriminately, but then his moral level falls. He loses visions of Beatrice, Autumn falls in the fallen context, and Silicon Virtue and APRIL grow to rule a pornified, degraded world. The game is lost to APRIL's Robodrones who kill Autumn, Beatrice, and Ranger. So it is that actions based on the moral premise have consequences.

Ranger must walk a fine line—before he meets Autumn he can get food and lodging by working small jobs, or grinding on hotties at dance clubs and spending the night. He can steal food and money, but then he risks being caught and detained as APRIL grows more powerful.

Temptation abounds in the open-ended, real-world simulation. At any time Ranger can choose a life of surfing, shoplifting and stealing, driving his Jeep around Charleston, and grinding on hotties to 50 cent 'til Doomsday, but Autumn alone can help Ranger escape west in her '69 Stingray Corvette, and she's leaving for an open mike night in Nashville.

The American Landscape:

A preferred embodiment would feature America's rich history and rugged landscape, her pastoral towns and strip malls, spanning the continent with views of historic monuments and breathtaking scenery. Every now and then Autumn must visit a bookstore—Barnes & Noble or Borders—so Autumn can buy one of her favorite books—a classic ranging from Moby Dick to Shakespeare's Sonnets.

The more Ranger plays to Autumn's romantic side, the more loyally she fights. The more he pauses to read her classic poetry and the Bible, the more their moral levels are raised. In addition to saving APRIL's soul, Ranger must save the culture's soul. He must beat the crap out of hipster deconstructionist poets at bookstore readings, so as to raise his moral level meter. If Ranger doesn't kick their asses, his moral level falls, and eventually they displace all classical culture—all that is noble and profound—with their postmodern crap, and one of them takes off with Autumn and turns her into a porn star.

Autumn's love of country and passion regarding the American Founding is continually on display during the westward journey, as she quotes the Founding Fathers and sings country/rock classics while traveling west. The game exalts the fantastic American Spirit, and songs from contemporary singer/songwriters Vaughn Penn and Tift Merritt are featured alongside Johnny Cash, Tammy Wynette, Kid Rock, and 50 cent.

Ranger can hand different books to Autumn read on their Journey on West, and the more he hands her the bible, the higher her morality augments.

Gameplay:

Autumn and Ranger risk being spotted by SF agents and RoboClones on major roads as they trek across America, but if they take too long on backroads, APRIL and her RoboClones will be too powerful by the time they get to Doom Mountain.

They can risk stealing money and food, but then their morality level meter declines, and Beatrice, their guiding angel, disappears. The best way to make a living is by Autumn's performances. In small towns Ranger can make posters for Autumn at Kinkos. The harder he promotes her, the bigger the crowd, and the more money they make. But around every corner lurks a drone, agent, or RoboClone, and they must continually keep moving.

Free Will/Moral Choice:

Ranger can do as he pleases. He can drive around Charleston, visiting hiphop clubs, surfing, and grinding on hotties to 50 Cent, but his morality level meter will decline, the angel Beatrice will no longer visit him providing hints, direction, and purpose; and eventually APRIL's RoboDrones will find him and kill him. If Ranger gives in to temptation and visits strip clubs in Nashville or Vegas, his moral meter will decline, and he will lose Autumn's respect. If he wanders too far off the straight and narrow, he'll break Autumn's heart and the angel Beatirce will no longer help him. If Ranger lets the culture slip by, forsaking his calls to duty, eventually Autumn will partake in porn, APRIL will be lost, and nuclear bombs will detonate in major American cities. And so it is that the American Empire will decline.

The happier he keeps Autumn, the more he walks the straight and narrow, the higher his morality level will be, and the less Autumn will drink, the better she will fight, and the more likely their success.

So it is that the present invention creates a moral feedback loop in the AI of the game, wherein way leads on to way and moral behavior begets moral behavior from other characters in the game. So it is that the opportunity to lead on a grander, dramatic scale is introduced, and deeper storytelling is granted to the player of the game endowed with the technology disclosed within.

Vehicles:

F-22 Raptor: An advanced tactical fighter with variable thrust, capable of near right-angle turns. '69 StingRay Corvette: This is Autumn's ride. It is midnight blue, but they must repaint it different colors in order to hide as they drive cross country.

Horses:

Harleys:

Miscellaneous Cars:

The Characters:

The Good:

Ranger McCoy: US Marine Fighter Pilot & Physicist who invents APRIL

Autumn West: folk singer RoboClone built by APRIL and sent to help Ranger before APRIL was corrupted by silicon virtue.

Beatrice: Beatrice is an angel. She was Ranger's first summer love who passed away on July fourth when she and Ranger were fourteen, when she came back to save Ranger after they where assaulted by men while riding horses. Throughout the game she visits in flashbacks and glimpses of the future, helping Ranger as long as he's doing the right thing. When APRIL created Autumn, she based Autumn's spirit on Ranger's memories of Beatrice. Autumn is who Beatrice might have become, had she lived.

The Bad:

Tucker Johnson: Tucker is the pomo-hipster Harvard MBA and CEO of Silicon Virtue who stole APRIL to build weapons of mass destruction. Tucker leases her power to the highest bidders, including terrorists who're building a nuclear bomb they plan to place on a tanker. RoboClones: APRIL engineers these part-human/part-machine warriors, and sends them after Ranger. At first they resemble Orcs, but as time goes on, the more lethal models resemble humans. RoboDrones/RaptorDrones: These are genetically-engineered, winged robo-beasts. At first they are hawk-like, but as time goes on they begin to resemble giant raptors, with complete weapons systems including lasers and missiles.

Kid Cowboy & Deputies: Kid Cowboy is, one of the Marines Ranger saves from terrorists by completing his air-support mission. But back in the states, Kid Cowboy, Sergeant Griffin's son, becomes a bounty hunter. He and his Harley-riding deputies are always closing in on Autumn and Ranger. Kid Cowboy is a skilled martial artist, and although Ranger can easily defeat him at first, Kid's skills increase as time goes on.

The Neutral:

Autumn: The AI in Autumn's game character can swing good or bad. When Ranger behaves morally, it exalts Autumn, and she behaves morally too. When Ranger behaves immorally, Autumn's character also declines, and she is less likely to help Ranger or collaborate on achieving the greater goal of the game embodied in the underlying moral premise.

APRIL: When Ranger designed APRIL at MIT—the world's first AI supercomputer, he left her with a moral operating system which always “turned the other cheek.” Thus she's incapable of defending herself against Silicon Virtue's hacks which eventually compromise her soul. Ranger wears the ring that can activate her deeper operating system “Penelope” which would allow her to defend herself and serve the higher ideals instead of SV's bottom line.

Sergeant Griffin: Griffin was the platoon leader of the Marines Ranger must save during the air support missions, and returns the favor by helping Ranger escape Kuwait, when the Pentagon is holding Ranger for Silicon Virtue, until Ranger gives up the codes. “Give up the codes,” sergeant Griffin says, “and you'll go home a hero.” Ranger can go home a hero, with money and mansions, but APRIL will become evil and terrorist will use her to build bombs and detonate them in America. If Ranger refuses to give up the codes, eventually Sergeant Griffin gives him a shiphand's ID for a tanker. Sergeant Griffin tells Ranger that he's ready to retire, and that he's going to work for DigiWar, a corporate security firm. Griffin becomes the chief of security, and DigiWar is hired by Silicon Virtue. Early on, Griffin is reluctant to pursue Ranger, but eventually Griffin is turned against him, and ultimately Silicon Virtue replaces Griffin and his men with APRIL's RoboClones.

3DE Model RoboClones: 3D Entertainment Inc., a Hollywood company run by the sleazy Andrew Anderson, is using APRIL to manufacture Roboclone Models for the entertainment industry. It so happens that all the RoboClone models, which resemble Autumn, have super powers which Ranger's ring can unclock. In order to penetrate the heavily-fortified Doom Mountain, Autumn and Ranger's only hope is to lead an underdog army of RoboClone models in a battle against APRIL's RoboClone Warriors.

The Ugly: The most formidable RoboClone guards APRIL in her lair. The Tucker Johnson RoboClone is willed remotely by Tucker Johnson, who sits in a reinforced room as the awesome RoboClone tears Ranger apart, as Ranger protects Autumn as her soul uploads.

The Showdown:

After battling APRIL's fierce RoboClone army, and making it a mile deep into Doom Mountain. Ranger must load Autumn's soul into APRIL. As she lays in the soul-mapping chair, Ranger battles the super-fast, super-lethal Tucker RoboClone. There is no way for Ranger to win. All he can do is use his body to shield Autumn. Ranger will die protecting Autumn. And only by dying will he be resurrected.

Epilogue:

After Autumn's soul uploads, APRIL sees herself for what she has become. Empowered with a higher morality, APRIL is horrified by all she has created. She sends Raptor Robodrones to contain the nuclear bombs terrorists have placed on oil tankers. Before destroying Doom Mountain and all she has created there, she brings Ranger back to life.

Autumn and Ranger move to Wyoming to live a quiet family life on a farm. But peace never lasts long for those who live by higher ideals, and soon enough, another crisis calls the duo into action in AUTUMN RANGERS II.

Gameplay:

The fate of the world rests upon Ranger's shoulders. If he doesn't upload APRIL with a higher morality, the world will be overcome by APRIL's roboclones, and nuclear bombs will detonate in NY and LA.

The genius of Autumn Rangers is that it the plots and subplots are unified, and the physical and spiritual quests are one and the same. Ranger must save Autumn's soul to save APRIL's soul. Beatrice and Autumn help Ranger when he is doing the moral thing. Beatrice and Autumn ignore Ranger when he is doing the amoral or immoral thing. APRIL becomes more and more evil, as Silicon Virtue evicts the Beatrice operating system from her soul. A copy of the Beatrice operating system exists in Autumn's soul, so to lose Autumn is to lose the quest. Ranger must make it to APRIL with Autumn to upload the copy of Beatrice in Autumn's soul. The physical copy of Beatrice in Autumn's soul is the physical manifestation of the visions of Beatrice that Ranger sees, as Beatrice was originally Ranger's first love who passed away long ago. APRIL created Autumn and copied Beatrice into her when APRIL realized she was being hacked and overtaken by Silicon Virtue. APRIL sent Autumn to find Ranger, but then APRIL forgot about this.

So it is that numerous circular unities embody the plot of Autumn Rangers, granting it a classical place in the realm of novels, movies, and video games.

### DESCRIPTION OF PREFERRED EMBODIMENTS WITH DRAWINGS

It is not the point of this patent application to duplicate the common knowledge of the construction of video game consoles and systems as described and illustrated and embodied extensively in the prior art, including the Playstation systems, the Xbox systems, the PC gaming systems, and the drawings and descriptions of a game console system in U.S. Pat. No. 6,935,954. The present invention could be rendered on all of these platforms, as well as others, by someone reasonably skilled in the art.

This invention offers a novel way to incorporate morality and a moral premise within the realm of video games, as the preferred embodiments, described both with and without drawings, will demonstrate.

### BRIEF DESCRIPTION OF THE DRAWINGS

These and other aspects of the present invention will be described in detail with reference to the accompanying drawings, in which:

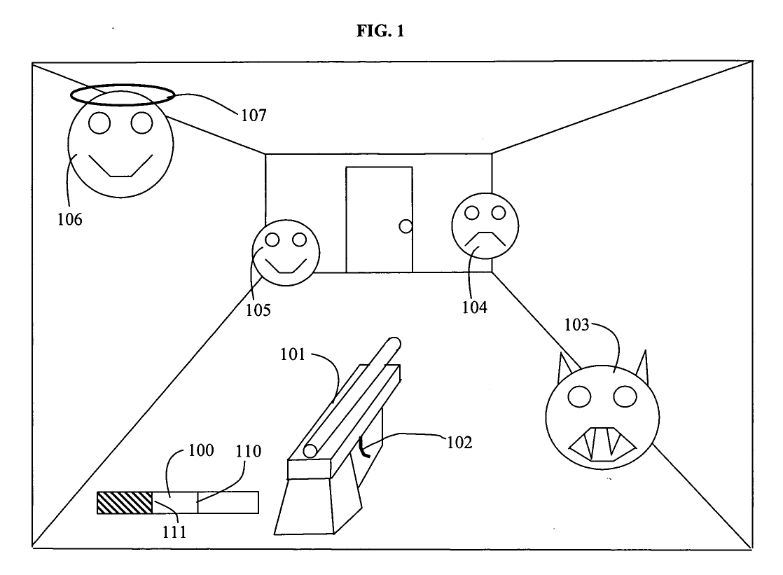

FIG. 1 is an exemplary screenshot of the present invention showing the morality meter,

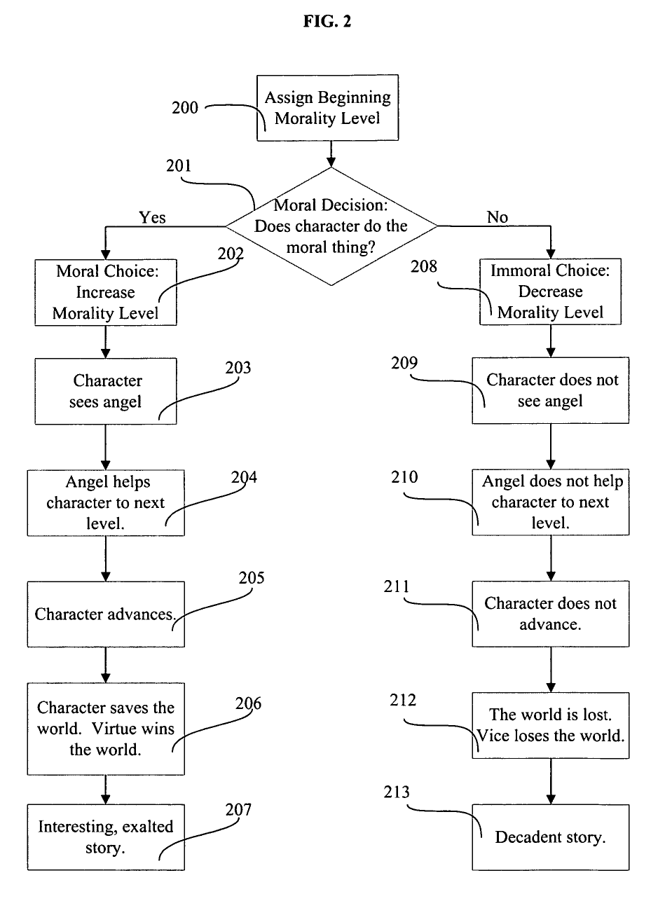

FIG. 2 is a flowchart showing a method of the present invention,

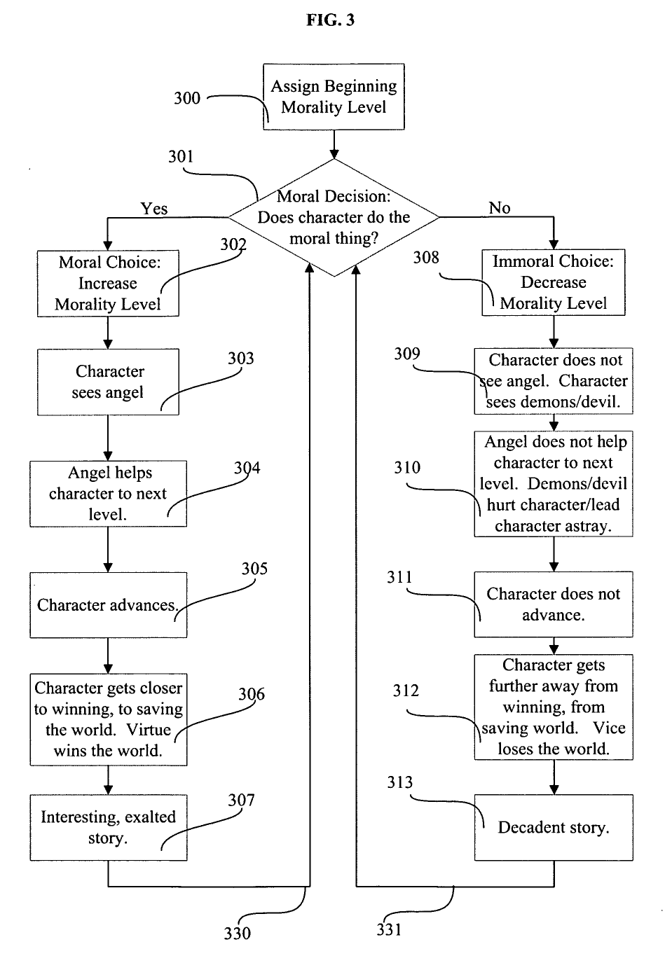

FIG. 3 is a flowchart showing a method of the present invention,

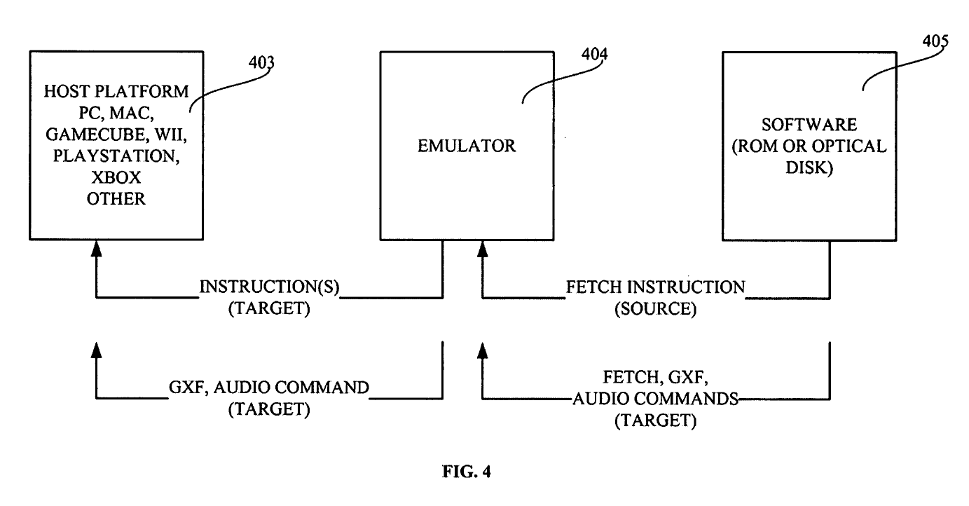

FIG. 4 illustrates an example overall emulation process, whereby the present invention may be manifested upon various platforms,

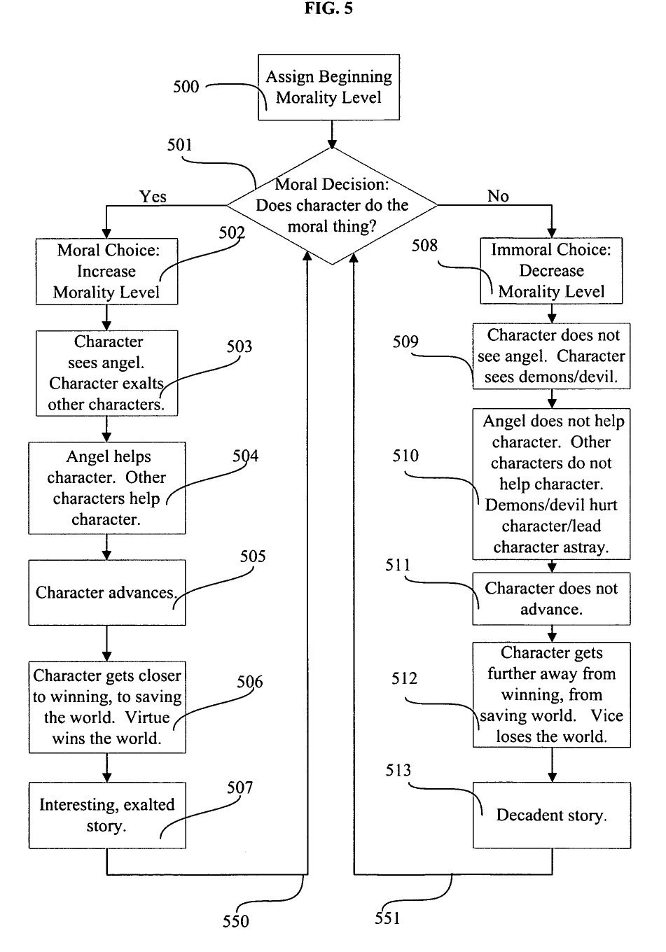

FIG. 5 is a flowchart of a method of the present invention,

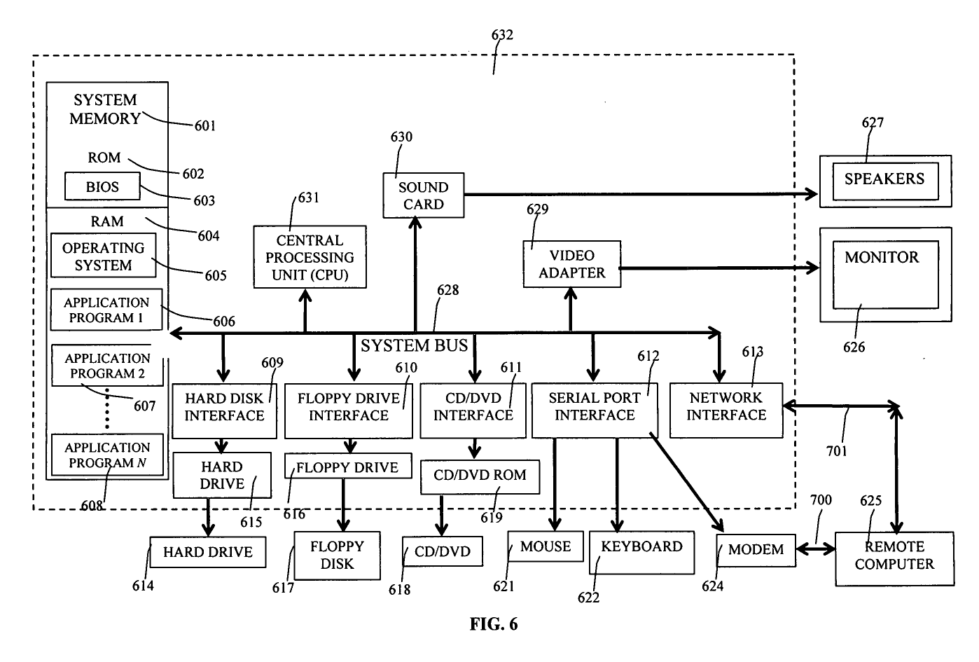

FIG. 6 illustrates an emulation host system, representing a PC or a Macintosh or other computer system that could be used to operate or run the present invention, and

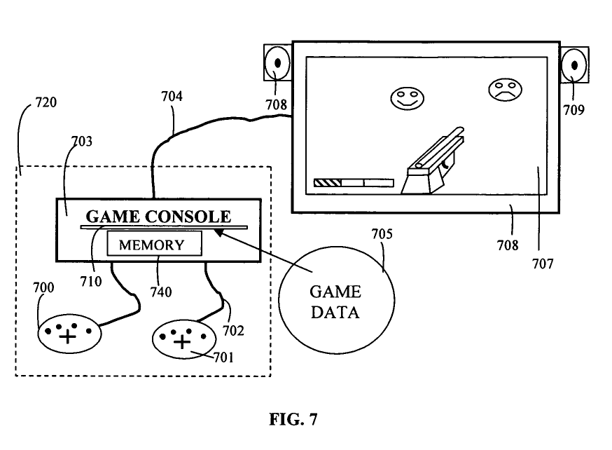

FIG. 7 is an exemplary drawing of a game console system representing but not limited to an Xbox, a Playstsation, a Gamecube, a Wii, and other games.

### DETAILED DESCRIPTION OF PREFERRED EMBODIMENTS

The following description of basic video game consoles, systems, and setups on PCs and Macintosh computers are very similar to those systems described in U.S. Pat. No. 6,935,954. However, the novel feature of a morality system and method in the present invention leads to vastly different results and consequences. The novel results and consequences include new and enhanced features in the realm of video game design, including epic storytelling, superior game play, deeper characters, more emotionally-involving video games, and higher art in the realm of video games, resulting in superior brands and augmented audiences, markets, and game longevity.

FIG. 7 shows a game console system 720 that constitutes a suitable game machine for playing games incorporating the morality feature of the present invention. The video game system 720 includes a main console 720, a video game storage device 705, and handheld controllers 700 and 701 (or other user input devices), which are connected to the console, either wirelessly or with wires 702. Video game system 720 may be, for example, the Playstation®, Xbox®, Nintendo 64®, or other video game system. Main console 703 is connected to a conventional home color television set 706 or HDTV 706 via a cable 704. Television set 706 displays three-dimensional (3-D) video game images on its television screen 707 and reproduces stereo sound through its speakers 708 and 709.

Video game storage device 705 is typically in the form of a replaceable CD or DVD ROM insertable into a slot 710 in console 703. A wide variety of alternative program storage media such as CD ROMs, DVDs, floppy disks, and the like may be utilized. ROM and RAM 740 may store the current game and the RAM 740 may store current details of the state of the current game, including points, level, morality level, health, score, names and more.

Additional details of game system 720 may be found in U.S. Pat. No. 6,022,274 and U.S. Pat. No. 6,935,954 the contents of which are incorporated herein by reference.

The following description of basic video game consoles, systems, and setups on PCs and Macintosh computers are very similar to those systems described in U.S. Pat. No. 6,935,954. However, the novel feature of a morality system in the present invention leads to vastly different consequences in the realm of video game design, including epic storytelling, superior gameplay, deeper characters, more emotionally-involving video games, and higher art in the realm of video games, resulting in superior gameplay and brands and augmented audiences, markets, and game longevity.

Certain of the above-described system components could be implemented as other than the home video game console configuration described above. For example, one could run graphics application or other software written for system 720 on a platform with a different configuration that emulates system 720 or is otherwise compatible with it. If the other platform can successfully emulate, simulate and/or provide some or all of the hardware and software resources of system 720, then the other platform will be able to successfully execute the software.

As one example, an emulator may provide a hardware and/or software configuration (platform) that is different from the hardware and/or software configuration (platform) of system 720. The emulator system might include software and/or hardware components that emulate or simulate some or all of hardware and/or software components of the system for which the application software was written. For example, the emulator system could comprise a general-purpose purpose digital computer such as personal computer, which executes a software emulator program that simulates the hardware and/or firmware of system 720. The DSP processing of the above-described audio system could be emulated on a personal computer.

Some general purpose digital computers (e.g., IBM or MacIntosh personal computers and compatibles) are now equipped with 3D graphics cards that provide 3D graphics pipelines compliant with DirectX or other standard 3D graphics command APIs. They may also be equipped with stereophonic sound cards that provide high quality stereophonic sound based on a standard set of sound commands. Such multimedia-hardware-equipped personal computers running emulator software may have sufficient performance to approximate the graphics and sound performance of system 720. Emulator software controls the hardware resources on the personal computer platform to simulate the processing, 3D graphics, sound, peripheral and other capabilities of the home video game console platform for which the game programmer wrote the game software.

FIG. 4 illustrates an example overall emulation process using a host platform 403, an emulator component 404, and a game software executable binary image provided on a storage medium 405. Host 403 may be a general or special purpose digital computing device such as, for example, a personal computer, a video game console, or any other platform with sufficient computing power. Emulator 404 may be software and/or hardware that runs on host platform 403, and provides a real-time conversion of commands, data and other information from storage medium 405 into a form that can be processed by host 403. For example, emulator 404 fetches “source” binary-image program instructions intended for execution by system 720 from storage medium 405 and converts these program instructions to a target format that can be executed or otherwise processed by host 403.

As one example, in the case where the software is written for execution on a platform using an IBM PowerPC or other specific processor and the host 403 is a personal computer using a different (e.g., Intel) processor, emulator 404 fetches one or a sequence of binary-image program instructions from storage medium 405 and converts these program instructions to one or more equivalent Intel binary-image program instructions. The emulator 404 also fetches and/or generates graphics commands and audio commands intended for processing by a graphics and audio processor, and converts these commands into a format or formats that can be processed by hardware and/or software graphics and audio processing resources available on host 403. As one example, emulator 404 may convert these commands into commands that can be processed by specific graphics and/or or sound hardware of the host 403 (e.g., using standard DirectX, OpenGL and/or sound APIs).

The emulator 404 used to provide some or all of the features of the video game system described above may also be provided with a graphic user interface (GUI) that simplifies or automates the selection of various options and screen modes for games run using the emulator. In one example, the emulator 404 may further include enhanced functionality as compared with the host platform for which the software was originally intended.

FIG. 6 illustrates an emulation host system 632 suitable for use with emulator 404. System 632 includes a processing unit 631 and a system memory 601. A system bus 628 couples various system components including system memory 601 to processing unit 631. System bus 628 may be any of several types of bus structures including a memory bus or memory controller, a peripheral bus, and a local bus using any of a variety of bus architectures. System memory 601 includes read only memory (ROM) 602 and random access memory (RAM) 604. A basic input/output system (BIOS) 603, containing the basic routines that help to transfer information between elements within personal computer system 632, such as during start-up, is stored in the ROM 602. System 632 further includes various drives and associated computer-readable media. A hard disk drive 615 reads from and writes to a (typically fixed) magnetic hard disk 614. An additional (possible optional) magnetic disk drive 616 reads from and writes to a removable “floppy” or other magnetic disk 617. An optical disk drive 619 reads from and, in some configurations, writes to a removable optical disk 618 such as a CD/DVD ROM or other optical media. Hard disk drive 615 and optical disk drive 619 are connected to system bus 628 by a hard disk drive interface 609 and an optical drive interface 611, respectively. The drives and their associated computer-readable media provide nonvolatile storage of computer-readable instructions, data structures, program modules, game programs and other data for personal computer system 632. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules including emulator 404 may be stored on the hard disk 614, removable magnetic disk 617, optical disk 618 and/or the ROM 602 and/or the RAM 604 of system memory 601. Such program modules may include an operating system providing graphics and sound APIs, one or more application programs, other program modules, program data and game data. A user may enter commands and information into personal computer system 632 through input devices such as a keyboard 622, pointing device 621, microphones, joysticks, game controllers, satellite dishes, scanners, or the like. These and other input devices can be connected to processing unit 601 through a serial port interface 612 that is coupled to system bus 628, but may be connected by other interfaces, such as a parallel port, game port Fire wire bus or a universal serial bus (USB). A monitor 626 or other type of display device is also connected to system bus 628 via an interface, such as a video adapter 629.

System 632 may also include a modem 624 or other network interface means for establishing communications over a network 701 such as the Internet. Modem 624, which may be internal or external, is connected to system bus 628 via serial port interface 612. A network interface 613 may also be provided for allowing system 632 to communicate with a remote computing device 625 (e.g., another system 632) via a local area network 701 (or such communication may be via wide area network 700, 701 or other communications path such as dial-up or other communications means). System 632 will typically include other peripheral output devices, such as printers and other standard peripheral devices.

In one example, video adapter 629 may include a 3D graphics pipeline chip set providing fast 3D graphics rendering in response to 3D graphics commands issued based on a standard 3D graphics application programmer interface such as Microsoft's DirectX 9.0 or other version. A set of stereo or surround sound loudspeakers 627 is also connected to system bus 628 via a sound generating interface such as a conventional “sound card” providing hardware and embedded software support for generating high quality stereophonic sound based on sound commands provided by bus 628. These hardware capabilities allow system 632 to provide sufficient graphics and sound speed performance to play software stored in storage medium 614.

The above system is further elaborated on in U.S. Pat. No. 6,935,954. During video game play, a game character may be exposed to many horrific scenes such as the choice they make will effect a game character's morality.

FIG. 1 represents an exemplary screenshot of the present invention, where the player's morality is shown via a bar graph 100. The player is given a moral choice as to what action to take. In a preferred embodiment, the player is given a gun 101. If they pull the trigger 102 via their console and shoot the good 105, their moral level meter 100 decreases. If they shoot the bad 104, their morality level 100 increases. When the player's moral level meter rises to a certain threshold, 110 they may see angels or gods or other players 106 who will help them. When a player's moral level decreases to a certain threshold 111, they may encounter devils and demons 103 and other antagonists who may injure them. The gods and angels who appear when the player's moral level passes a higher threshold 110 may be marked with haloes 107, and they may help the player in various ways, including healing them, giving them guidance has to how to complete the game's level or quest, or helping them battle the bad 104 and the demons 103. FIG. 1 presents only one of potentially thousands upon thousands of moral decisions that might occur in a game, that game designers can include. But the overarching principle is that a player's moral level 100 is affected by their moral decisions, as well as the moral level of the surrounding environment, including the appearance and absence of angels and helpers 106 and demons and antagonists 103 proportional to a player's moral level 100. The moral level meter 100 may be explicitly displayed, or it may be concealed, but yet still manifested by the appearance and absence of angels and helpers 106 and demons and antagonists 103 proportional to a player's moral level 100.

Furthermore, moral choices, in addition to choosing whom to shoot in FIG. 1, may be based on precepts such as Benjamin Franklin's 13 precepts and the Bible's Ten Commandments, and then naturally mapped onto the various stages of Joseph Campbell's Hero's Journey. Moral choices may be based upon entities that include:
whom the character chooses to help
whom the character chooses to hurt
what a character donates or gives away
the types of books a character reads
the types of music a character listens to
the types of books a character give to other in-game characters to read
the types of establishments a character enters
what a character steals or does not steal
what a character worships
the generosity of a character
the risks a character takes to save others
an overall morality rating/ranking provided by other players in an online (MMORPG or MORPG) game
an overall morality rating/ranking provided throughout a character's lifetime of contributions

For example, a predetermined or relevant amount of morality may be added or subtracted based on the weight of each moral decision.

FIG. 2 illustrates a method of the present invention in flowchart representing an exemplary embodiment. The player is born into the world with a morality level 200. The morality level can be changed via baptism or other ritual before a player starts their mission. Then, during the course of the mission, the player encounters a moral dilemma 201. The player must make a moral decision at 201 that defines a plot point, taking a player down one of two or more roads. The player can choose between several possibilities of different moral value designated by the designers of the game. And just as epic movies and literature succeed by divine moral premises, so too shall the game play be considered enjoyable relative to the moral premises present.

If the player makes a moral choice 202, the character's morality level increases 202, and the character sees an angel 203. The angel helps the character, giving them advice and direction 204 and guiding them to the next level 205. Because the character advances 205, the character is able to win the game and save the world 206. An interesting, exalted story is told 207.

If the player makes an immoral choice 208, the character's morality level decreases 208. The character does not see the angel 209, the angel does not help the character to the next level 210, the character does not advance in completing or winning the game 211. The world is lost 212, and the result is a decadent 213 story.

FIG. 2. illustrates but one plot point in potentially hundreds or thousands of plot points which a game may include, consisting of many different types of decisions, all of which impact the character's moral level.

So it is that the present invention's system and method leads to video games that illustrate the same simple moral premise that all classic literature is founded upon: virtue leads to success and vice leads to failure.

In accordance with the invention, generally the character's morality affects the morality of other characters around them. When they do the right thing, other characters are exalted and join in. When they stray from the straight and narrow, other characters also lose the faith.

In accordance with the invention, another method to help the character's morality is research and knowledge. In other words, if the character knows the Great Books and the Bible, they will be better able to assess the correct course of action. The game program may also provide moral aids including, for example, items such as Bibles, Great Books, and spiritual guides that can aid the mind of the player against the darkest evil and reduce the morality loss.

FIG. 3 illustrates a method of the present invention in flowchart representing an exemplary embodiment, including gods, angels, demons, and devils. The player is born into the world with a morality level 300. The morality level can be changed via baptism or other ritual before a player starts their mission. Then, during the course of the mission, the player encounters a moral dilemma 301. The player must make a moral decision at 301 that defines a plot point, taking a player down one of two or more roads. The player can choose between several possibilities of different moral value designated by the designers of the game. And just as epic movies and literature succeed by divine moral premises, so too shall the game play be considered enjoyable relative to the moral premises present.

If the player makes a moral choice 302, the character's morality level increases 302, and the character sees an angel 303. The angel helps the character, giving them advice and direction 304 and guiding them to the next level 305. Because the character advances 305, the character gets closer to winning the game and/or saving the world 306. An interesting, exalted story is contributed to on multiple levels via the simple advancement of the story via this plot point 307.

The character moves on 330 with a higher morality meter, and they are presented with another moral decision 301. If they make the right or virtuous choice, their morality may be augmented even more, and they may receive additional, even greater, help form the goods and angels. If they make a wrong choice, their morality will be decremented, and the angels and gods will abandon the character to a further degree, while demons and devils will manifest themselves, proportional to level of the player's morality meter.

However, if upon facing the moral dilemma 301, the player makes an immoral choice 308, the character's morality level decreases 308. The character does not see the angel 309, but the character instead sees demons and devils 309. The angel does not help the character to the next level 310 and the demons and devils hurt the character and/or impede the character's progress towards the next level 310. The character does not advance in completing or winning the game 311. The character is further away from saving the world and closer to losing it 312, and the result is a progression towards a decadent 313 story.

The character moves on 331 with a lowered morality meter, and they are presented with another moral decision 301. If they make the right or virtuous choice, their morality may be augmented. If they make a wrong choice, their morality may be decremented even further, and more and/or fiercer demons will attack and/or impede them, and the angels and gods will abandon the character to a further degree, proportional to level of their morality meter.

FIG. 3. illustrates but one plot point in potentially hundreds or thousands of plot points which a game may include, consisting of many different types of decisions, all of which impact the character's moral level.

So it is that the present invention's system and method leads to video games that illustrate the same simple moral premise that all classic literature is founded upon: virtue leads to success and vice leads to failure.

FIG. 5 illustrates a method of the present invention in flowchart representing an exemplary embodiment, including gods, angels, demons, and devils, as well as other in-game characters that may help or hurt the player's character based upon their moral choices. The player is born into the world with a morality level 500. The morality level can be changed via baptism or other ritual before a player starts their mission. Then, during the course of the mission, the player encounters a moral dilemma 501. The player must make a moral decision at 501 that defines a plot point, taking a player down one of two or more roads. The player can choose between several possibilities of different moral value designated by the designers of the game. And just as epic movies and literature succeed by divine moral premises, so too shall the game play be considered enjoyable relative to the moral premises present.

If the player makes a moral choice 502, the character's morality level increases 502, and the character sees an angel 503. The angel helps the character, as do other in-game characters such as a romantic interest or a friend, giving them advice and direction 504, perhaps helping them battle demons, devils, antagonists, and monsters, and guiding them to the next level 505. Because the character advances 505, the character gets closer to winning the game and saving the world 506. An interesting, exalted story is being contributed to via the player's chosen navigation of the plot point 507.

So it is that this present invention brings deeper romantic relationships, defined within a moral context, to life.

The character moves on 530 with a higher morality meter, and they are presented with another moral decision 501. If they make the right or virtuous choice, their morality may be augmented even more, and they may receive additional, even greater, help from the gods and angels. If they make a wrong choice, their morality will be decremented, and the angels and gods will abandon the character to a further degree, while demons and devils will manifest themselves, proportional to level of the player's morality meter.

However, if upon facing the moral dilemma 501, the player makes an immoral choice 508, the character's morality level decreases 508. The character does not see the angel 509, but the character instead sees demons and devils 509. The angel does not help the character to the next level 510 and the demons and devils hurt the character and/or impede the character's progress towards the next level 510. Furthermore, other in-game characters including but not limited to romantic interests and friends may elect to abandon the character, or not help them. The character does not advance in completing or winning the game 511. The character is further away from saving the world and closer to losing it 512, and the result is a progression towards a decadent 513 story.

So it is that this invention brings deeper romantic relationships, defined within a moral context, to life.

The character moves on 531 with a lowered morality meter, and they are presented with another moral decision 501. If they make the right or virtuous choice, their morality may be augmented. If they make a wrong choice, their morality may be decremented even further, and more and/or fiercer demons will attack and/or impede them, and the angels and gods will abandon the character to a further degree, proportional to level of their morality meter.

FIG. 5. illustrates but one plot point in potentially hundreds or thousands of plot points which a game may include, consisting of many different types of decisions, all of which impact the character's moral level.

So it is that the present invention's system and method leads to video games that illustrate the same simple moral premise that all classic literature is founded upon: virtue leads to success and vice leads to failure.

Preferably, levels of morality will be on sliding scale. The more severe the immorality (i.e., the lower the character's moral level), the more demons and devils the player will have to face, and the less they will be helped by angels and gods. There may be a certain number, such as three, distinct levels of morality loss.

The game designers incorporating this morality feature may lay out points of interest by way of locales where moral decisions, based on a unifying moral premise, must be made. These plot points will allow the game to cause the character to physically manifest their internal moral code upon the screen, resulting in deeper game play. Such plot points will lead to deeper character development and story.

The targeting system may also be affected when the character is immoral.

As noted, the character may experience different features of gameplay as a result of their moral level. Different aspects of gameplay may occur in the following exemplary forms for players with higher moralities achieved via moral choices in the game:
visions of angels
visions of gods
visions of goddesses
angels giving advice
gods giving advice
goddesses giving advice
angels aiding in battle
gods aiding in battle
goddesses aiding in battle
angels healing
gods healing
goddesses healing character
other characters helping character
other characters helping character
other characters giving advice to character
character wins romantic partner
character gains dream

Different aspects of gameplay may occur in the following exemplary forms for players with who suffer lowered moralities via immoral choices made in the game:
visions of demons
visions of devils
empowered antagonists
absence of angels
absence of gods
absence of goddesses
absence of moral purpose
absence of moral direction
absence of direction
absence of help from other in game characters
other in game characters are demoralized
other characters turn towards decadence
character loses romantic partner
goddesses healing character
other characters helping character
other characters helping character
other characters giving advice to character
character loses romantic partner
character loses dream

In addition to the visual effects and action-driven on-screen events, the game may also be programmed to cause audio effects as a result of the current level of morality of the character. For example, the character and thus the player may experience the following audio effects:
Classical music and/or heavy metal and/or rap and/or country
Ambient environmental sounds that get amplified or distorted or softened
Heartbeat of character increases/decreases
Wind
Lightning
Cavern/damp-dripping sewer sound
Creatures sounds
Footsteps
Earth rumbles (e.g. great beast foot steps, may also be synchronized with Rumble Pak and camera shake)
Loud noises coming from beyond a doorway, but when opened there is only silence
Whispering sounds coming from random locations that fade in and out
Voices of Gods and angels and in game characters giving direction and encouragement
Voices of devils and demons giving voices of damnation

In accordance with the present invention, the morality feature can be programmed into any suitable video game using known programming techniques for the purpose of enhancing game play. As explained above, the morality of the player's character will be affected by decisions made, enemies faced, as well as any other suitable occurrences and choices that may relate to morality. As the character loses gains or loses morality, the environment and other in game characters, including but not limited to gods, angels, devils, and demons will change in a way that helps or hinders the player's character progress through the game. The present invention provides an added challenge and enables multiple possible scenarios, so that playing of the game may be different each time the game is played, resulting in different stories. Furthermore, deeper, more exalted stories will be realized by this invention. Furthermore, more meaningful relationships, both romantic and based on platonic friendship, will arise via the system and method for morality of the present invention. It is noted that the invention is particularly suited for implementation in action/adventure/RPG games, but that it may be used in any suitable video game or the like, such as MMORPGs, first person shooters, third person shooters, and others.

### DETAILED DESCRIPTION PREFERRED EMBODIMENT #2: DANTE'S INFERNO GAME:

As Dante wrote about Beatrice—his true love who passed away—in La Vita Nuova:

After this sonnet there appeared to me a marvelous vision in which I saw things which made me decide to write no more of this blessed one until I could do so more worthily. And to this end I apply myself as much as I can, as she indeed knows. Thus, if it shall please Him by whom all things live that my life continue for a few years, I hope to compose concerning her what has never been written in rhyme of any woman. And then may it please Him who is the Lord of courtesy that my soul may go to see the glory of my lady, that is of the blessed Beatrice, who now in glory beholds the face of Him who is blessed forever.—Dante

Such sentiments must pervade video games in order for games to reach a higher level of art. A preferred embodiment of the present invention is the Dante's Inferno Game, which may incorporate morality either implicitly or explicitly via a moral level meter, the behavior of other in-game characters, and other means.

DANTE'S INFERNO GAME: Welcome to Dante's Inferno Game! We're a brand new game based on the Beatrice Game Engine! Sign up to be notified as we get underway!

Dante's Inferno is a first-person shooter that will be built with the Kismet Visual Scripting System™ included in the Unreal 3.0 Engine® that will be released with Unreal Tournament 2007®. The game may also be built with open source engines or GarageGames.com's Torque engine. At any rate, we aim to become a repository for content supporting Dante's Inferno, built upon Open Source CMS with a 22surf philosophy.

With its classic story, fierce demons, rich imagery, and a cornucopia of pre-existing classical art depicting a descent through nine levels of Hell on towards the three-headed Satan himself, The Inferno naturally implies a video game.

Gameplay: In the Great Books Game's version, Dante must save the sinners from their demons—demons that have overtaken their bodies and transformed them into monsters. In each level of Hell, Dante battles the ever-more-sinister monsters, and upon defeating them, the original sinner is separated from the demon and allowed to escape to purgatory. Dante must separate the sinners from their sins to descend to the next level, en route to battling Satan.

Dante's moral level may be displayed on the screen via a moral level meter 100, and/or it may be manifested by how Beatrice interacts with him. If he shoots the sinners, his moral level meter 100 declines 111. If he shoots the demons, his moral level meter 100 augments 110. If he kills the sinners, his moral level declines 111. If he kills the demons, his moral level augments 110.

When Dante's moral level is high, he is visited by an angel named Beatrice who may help him or lead him on further through the game. When Dante's moral level is low, Beatrice does not visit him. Instead, when Dante's moral level is low, he is visited by demons who may impede his progress.

Design Team: Great Books Games is currently recruiting artists and level designers to help realize a version of Dante's Inferno that's as close as possible to Dante's original version. The official development will start in 2006, with the release of Unreal 2007.

Blending Public Domain & Proprietary: The game will utilize public domain art, music, art, and architecture, and it will release both educational and commercial versions of the game.

Design Philosophy: Modders may donate art and artwork utilizing Creative Commons licenses, or GBG may pay for the design/development of certain aspects of the game. GBG will develop an archive of artwork for Dante's Inferno as well as other Great Books including the Iliad and Odyssey, both public domain and proprietary, allowing the artists to define their rights and the price of their work.

Soundtrack: As Beethoven wrote nine symphonies and the Inferno has nine levels, Beethoven's symphonies will accompany Dante during his descent through Hell. Imagine battling Satan to Beethoven's ninth.

### ADDITIONAL PREFERRED EMBODIMENT: GREAT BOOKS GAMES

The present invention can bring the Great Books and literature, such as the Bible, to life via the Moral Level Meter™ and the Beatrice Game Engine™ disclosed in the present invention.

All the stories in the Great Books and classics are founded upon a moral premise and exalted morality. Thus the present invention, with its methods for introducing morality into the realm video games, is necessary to bring the soul and spirit of such classics to life as video games. Vast educational and commercial opportunities abound in the embodiment of present invention in the context of the Great Books.

Welcome to GREAT BOOKS GAMES! We're brand new! Sign up to be notified as we get underway! And join us in our classicstorytelling.com forums! Also check out Autumn Rangers, which was also inspired by Dante's Inferno.

Great Books Games aims to develop gaming franchises centered about rich stories contained in the Great Books. Dante's Inferno, with it's descent through nine levels of Hell and ever-more-sinister demons leading to a three-headed Satan, is the obvious place to start.

By using a combination of Open Source and proprietary philosophies, Great Books Games will marry public domain art, music, stories, and architecture to cutting-edge, proprietary game engines such as Epic's Unreal 3 engine, which will include the Kismet Visual Scripting System that will empower storytellers as game developers. And too Great Books games will marry the above to the present invention which includes the Beatrice Game Engine and concepts that introduce morality and a moral premise into video games, including the moral level meter 100 in FIG. 1.

GBG aims to create a public domain archive for art and architecture to support games based on classic stories, while also developing an Open Source content, collaboration, workflow, and community management system to support virtual game companies.

While EA says tomorrow's games will cost more, GBG believes tomorrow's games will cost less, thanks to new game development paradigms based on technology's inevitable march and Open Source philosophies:

1) Great Books Games, built upon the present invention, will inspire enduring franchises: as the technology advances, the story will stay the same. Dante's Inferno can continue inspiring next-generation games for hundreds of years.

2) GBG games, built upon the present invention, will have great educational value: as long as kids/teens are shooting/flying/racing, why not expose them to classical art and literature?

3) GBG games, built upon the present invention, will inspire cool, positive publicity, encouraging parents to purchase the games and schools and libraries to stock them.

4) GBG games, built upon the present invention, will have long shelf-lives: even an older version of The Odyssey will retain its aesthetic and educational appeal.

5) GBG, built upon the present invention which allows for epic storytelling based on a moral premise, can take advantage of public domain art, architecture, and music: rich games can be made at a fraction of the cost, and classical content can be modded and integrated by a small team.

6) Various stories/books can be blended in a seamless world, built upon the present invention, so that a player can meet the famous philosophers and characters, descending into Dante's Inferno and then fighting the Battle of Troy, with Beethoven playing in the background.

7) In multi-player mode, built upon the present invention, players could enter a giant game world as classical characters, such as Hamlet, Dante, or Juliet, where they could play different levels, corresponding to the classics.

8) As Hollywood and gaming merge, and storytelling becomes more pervasive in games, Joseph Campbell's Hero with a Thousand Faces can be manifested time and again within GBG, built upon the present invention that provides an enhanced ability to render story and character with greater depth.

9) After Dante's Inferno and The Odyssey, GBG could explore developing gaming worlds for famous historical battles, ranging from The Iliad to the Civil War, or giving tours of the Sistine Chapel or Parthenon.

10) By using a cutting-edge game engine such as Epic's Unreal 3 Engine, a small team could become a first mover in creating a lasting brand, built upon the present invention, which fosters higher art in the realm of video games.

11) By developing and providing a suite of Open Source community/content/collaboration/workflow tools to modders, artists, and storytellers all around the world, Great Books Games aims to help foster new paradigms in game development, built upon the present invention, which fosters higher art in the realm of video games.

The first ten Great Books Games™, built upon the present invention which allows epic story and moral premises to be brought to life in the realm of video games, could be:

1. Dante's Inferno

2. The Iliad

3. The Odyssey

4. Shakespeare's Hamlet

5. Shakespeare's Romeo & Juliet

6. The Red Badge of Courage (Civil War)

7. Moby Dick

8. Treasure Island

9. Bible Stories

10. The Aeneid

GBG games could take place in both classical and contemporary settings, reflecting that the classical moral premises this present invention brings to life are timeless. For instance, Dante's Inferno could present a classical interpretation of hell exactly as Dante described it, and/or it could be modded to present a contemporary hell, complete with Grand Theft Auto-like characters, corrupt politicians, infamous lawyers, Wall Street hypesters, and other “sinners.” An Open Source approach to content built upon a cutting-edge game engine would foster hybrid games.

### Other Embodiments

The system and method for morality in video games described in the present invention would allow rich game play and classical stories to emerge within an open ended game. In order for games to be more realistic, they must become more like life—they must be open ended—free will—but they must incorporate a higher morality—narrow is the road to heaven. The BGE incorporates a higher morality, weaving it into the characters and environment.

A video game and game system incorporating a game character's morality level that is affected by occurrences in the game such as moral, amoral, or immoral choices made by the player's character. A character's morality level is modified based on choices within a situation that presents a moral dilemma, including but not limited to who a player helps, who a player fights, what a player does or does not steal, who a player shoots, the types of establishments a player enters or does not enter, the music a player listens to, how the player treats other players, and the books a player chooses to read or not read along their journey in the game. The level of a character's morality in turn affects the game's environment. The player's morality level affects the way a player is treated by other characters, gods and angels, and devils and demons in the game. Such a feedback system based on simple moral premises will provide an efficient means to enhance and deepen game play, as a sensible, realistic, meaningful, profound, and epic story will naturally emerge. The presentation of moral dilemmas and the measurement of moral choices will allow a player's internal soul and moral being to be rendered upon the screen in cinematic video game action paralleling the internal spiritual drama and journey, thusly providing many of the dramatic elements that make classic literature and film enjoyable, entertaining, exalting, and educational. The presentation of moral choices in the game, based upon moral premises, will allow plot points that result in character arcs, plots, and epic story. A moral player may inspire other characters to help in the game's greater goal, while an immoral player might be abandoned in the game to walk the streets alone. A character with a higher morality level may be given more help and guidance by the angels and gods in the game, resulting in direction and purpose that allows them to win. A character with a lower morality level may be abandoned by the gods and angels, thusly losing purpose and direction in the game world, and too, a player with a lowered morality level may become haunted and hindered by devils and demons. Thus simple abstract moral premises wherein virtue leads to victory and vice leads to defeat will be rendered a physical and cinematic reality in a story upon the screen. And thus the dramatic action will parallel and deepen the physical action as it does in all classic action-adventure books and movies. As the character's morality level changes, game play is effected such as by controlling game effects and audio effects, creating hallucinations and the like, and changing the behavior of other in-game characters, gods, angels, devils, and demons. In this context, the same game can be played differently each time it is played, with a different story based on the same moral premises, each time. Deeper, more emotionally-involving game play will emerge, along with story. Furthermore, because morality and moral actions are at the center and circumference of all classical literature and eternal art, games built upon this invention will allow the games to achieve a superior form of story and drama hitherto unseen in the gaming industry. This invention will allow the classical spirit that pervades The Odyssey and Date's Inferno and Shakespeare and the Bible to be rendered in video games. A character's moral level may be displayed on the screen, or it may be manifested more subtly in the manner in which the game environment, the game AI, and other characters interact with the character. The introduction of the morality method and system in the present invention to action-adventure games, RPGs, FPSs, TPSs, MMORPGs, and other kinds of games would enhance the game play, allow for deeper character development, and result in improved and epic storytelling. The present invention brings deeper romantic relationships, defined within a moral context, to life; and it provides a means to take gaming to an improved and higher artistic, aesthetic, emotional, and educational level.

While several preferred embodiments of the present invention have been described herein, it is noted that various changes and modification may be made, as one skilled in the art will readily understand from the description of the invention herein. Thus, the description of the invention herein is not meant to be limiting to the true scope of the invention.

This invention will have far-reaching consequences in launching an artistic renaissance and economic revolution in next-generation gaming. The present invention will afford a novel breed of video games with an exalted spiritual level and epic storytelling. The present invention will thus expand the market for video games in hitherto unseen and novel ways.

I claim:

1. A method of operating a video game including a game character controlled by a player, the method comprising:
(a) setting a morality level of the game character;
(b) modifying the morality level of the game character and the world surrounding the character during game play according to occurrences in the game, wherein a modifying amount is determined based on said character's moral reaction and the morality of choices made by said character
(c) controlling game play according to the moral level of the game character, gameplay being controlled at least by varying game effects according to the game character morality level.

2. A method according to claim 1, wherein step (b) is practiced by reducing the morality level of the game character upon the player making an immoral or amoral choice.

3. A method according to claim 1, wherein step (b) is practiced by increasing the morality level of the game character if the game character acts in a moral manner, making a moral choice, during gameplay.

4. A method according to claim 1, wherein step (c) is practiced by gods or angels or other in game characters helping said game character that has a higher morality level.

5. A method according to claim 1, wherein step (c) is practiced by gods or angels or other in game characters abandoning, ignoring, or not helping the game character with a lower morality level or hiding extra information and purpose from the said character.

6. A method according to claim 7, wherein step (c) is further practiced by introducing devils and demons to fight or impede said game character with a lower morality level.

7. A method according to claim 1, wherein step (c) is practiced by varying game audio effects and soundtrack according to the morality level of the game character.

8. A method according to claim 1, further comprising displaying a morality meter that displays the morality level of said game character.

9. A method according to claim 1, further comprising integration within a social network or massively-multiplayer online role playing game, that will rank players in part based on the levels of their morality meters, so that players may become known by a permanent moral ranking.

10. A method of creating story in a video game including a game character controlled by a player, the method comprising:
(a) setting a morality level of the game character;
(b) presenting character with choices requiring moral evaluation, such choices becoming plot points;
(c) modifying the morality level of the game character and the world and other characters surrounding said game character during game play according to occurrences and choices made in the game, wherein a modifying amount is determined based on the morality of choices made by said game character
(d) controlling game play and story according to the moral level of the game character, game play and story being controlled at least by varying game effects, environment, and behavior of other characters and entities according to said game character's morality level.

11. A video game system including a control processor for playing a video game including a game character controlled by a player, the video game system comprising a setting unit communicating with the control processor that sets a morality level of the game character, wherein the morality level of the game character is modified during game play according to occurrences in the game including moral or immoral choices made by the player, and wherein a modifying amount is determined based on a character's moral, amoral, or immoral choice or action, the control processor controlling game play according to the moral level of the game character, wherein game play is controlled at least by varying game effects and other characters including gods, angels, and demons, according to the game character morality level.

12. A video game according to claim 11, wherein the morality level of the game character is reduced upon making an immoral or amoral choice.

13. A video game according to claim 11, wherein the moral level of the game character is increased if the game character behaves in a moral manner.

14. A video game according to claim 11, wherein game character reactions to player commands are detrimentally affected with decreasing morality.

15. A video game according to claim 11, wherein the game character is caused to lose sight of gods and angels and instead see demons with decreasing morality.

16. A video game according to claim 11, wherein gods and angels and other in-game characters and the game's artificial intelligence helps the character in proportion to their heightened morality level.

17. A video game according to claim 11, wherein demons and devils and other in game characters and the game's artificial intelligence hurts the character in proportion to their lowered morality level.

18. A video game according to claim 11, further comprising a morality meter that displays the morality level of the game character.

19. A video game system including a control processor for playing a video game including a game character controlled by a player, the video game system comprising
means for setting a morality level of the game character;
means for presenting the game character with choices of moral consequence, based on moral premises, and requiring moral considerations, said choices becoming plot points
means for modifying the morality level of the game character during game play according to occurrences in the game and choices made by the game character, wherein a modifying amount is determined based on the morality, amorality, or immorality of a character's choice; and
means for controlling game play according to the morality level of the game character, game play being controlled at least by varying game effects and the actions of other characters in the environment according to the game character's morality level.
